(19) United States
(12) Patent Application Publication
(10) Pub. No.: US 2017/0034293 A1
(43) Pub. Date: Feb. 2, 2017

(54) TECHNIQUES FOR DYNAMIC ENROLLMENT IN STORAGE SYSTEM NEWSGROUPS

(71) Applicant: NETAPP, INC., Sunnyvale, CA (US)

(72) Inventors: Jared Hocutt, Durham, NC (US); Marty Turner, Apex, NC (US)

(73) Assignee: NETAPP, INC., Sunnyvale, CA (US)

(21) Appl. No.: 14/840,408

(22) Filed: Aug. 31, 2015

Related U.S. Application Data
(60) Provisional application No. 62/199,648, filed on Jul. 31, 2015.

(51) Int. Cl. H04L 29/08; H04L 12/58

(52) U.S. Cl. CPC H04L 67/26; H04L 67/1046; H04L 51/14

(57) ABSTRACT

Various embodiments are generally directed to techniques for dynamically enrolling storage system administrators into one or more news feeds based on aspects of operation of the one or more storage systems that each storage system administrator oversees. An apparatus includes a processor component of an enrollment server; a selection component of the enrollment server to analyze an aspect of the storage of client data by at least one storage device of a storage system to determine a topic of interest to the operation of the storage system, and to enroll an administration device of the storage system as a recipient of a news feed based on the topic of interest; and a triggering component of the enrollment server to trigger a distribution server to transmit a document associated with the news feed to the administration device in response to the enrollment of the administration device.

### CROSS-REFERENCE TO RELATED APPLICATIONS

This application claims the benefit of priority under 35 U.S.C. §119(e) to U.S. Provisional Application Ser. No. 62/199,648 entitled “TECHNIQUES FOR DYNAMIC ENROLLMENT IN STORAGE SYSTEM NEWSGROUPS” filed Jul. 31, 2015, the entirety of which is incorporated herein by reference.

### BACKGROUND

Remotely accessed storage systems may provide storage services in support of multiple applications simultaneously in which each of the applications may have widely different storage requirements. To do so, such storage systems are often assembled from a complex collection of hardware and software components that may be selected from a wide range of options. Also, such storage systems may be used to provide storage for any of a wide variety of applications under any of a wide variety of circumstances. Further, as time passes, needs may change and available options for replacing and/or upgrading hardware or software components of the storage system may change. As a result, each storage system may be of a relatively unique configuration from the date of its installation and/or may become relatively unique over time.

As a result, administrators of such storage systems may encounter various challenges in diagnosing problems, maintaining, repairing and/or upgrading such storage systems. By way of example, administrators charged with overseeing multiple storage systems may be frustrated by differences among them resulting in situations where different solutions to similar problems must be derived and/or applied to different ones of those storage systems. This can complicate efforts to apply lessons learned from supporting one storage cluster system to supporting another storage cluster system. Stated differently, with so many ways in which multiple storage systems under the care of the same administrator may differ from each other, it may simply not be possible to be properly prepared to address every possible combination of circumstances that may be arise.

### BRIEF DESCRIPTION OF THE DRAWINGS

FIG. 1 illustrates an example embodiment of an administration system exchanging data with multiple storage systems.

FIG. 2A illustrates an example embodiment of an administration system.

FIG. 2B illustrates an alternate example embodiment of an administration system.

FIG. 3A illustrates an example embodiment of a collection server of an administration system.

FIG. 3B illustrates an example embodiment of an enrollment server of an administration system.

FIG. 3C illustrates an example embodiment of a documentation server of an administration system.

FIG. 3D illustrates an example embodiment of a distribution server of an administration system.

FIG. 4 illustrates an example embodiment of a storage cluster system.

FIG. 5A illustrates an example embodiment of a pair of high availability groups of a cluster.

FIG. 5B illustrates an example embodiment of a pair of high availability groups of different clusters.

FIG. 6 illustrates an example embodiment of a HA group of partnered nodes.

FIG. 7 illustrates an example embodiment of duplication and storage of metadata within a shared set of storage devices.

FIG. 8 illustrates an example embodiment of a mesh of communications sessions among nodes.

FIG. 9 illustrates a processing architecture according to an embodiment.

### DETAILED DESCRIPTION

Various embodiments are generally directed to techniques for dynamically enrolling storage system administrators into one or more news feeds based on aspects of operation of the one or more storage systems that each storage system administrator oversees. A collection server of an administration system may collect such information from multiple storage systems, and may store such information in an account database that associates particular storage systems with particular accounts. An enrollment server of the administration system may recurringly access the account database to recurringly determine topics of interest to administrators associated with each account, and may dynamically select one or more news feeds in which to enroll the administrator of each account based on recently determined of topics of interest. For each such enrollment, a distribution server of the administration system may select one or more documents tagged with an indication of association with a topic of interest of that news feed, and may transmit that document to administration devices associated with the administrators currently enrolled in that news feed.

The information collected from each storage system by the collection server may include indications of what hardware and/or software components make up the storage system, the manner in which those components are coupled, features of those components that are used and/or are not used, client applications for which client data is stored, the types and quantities of client data stored, occurrences of various events affecting storage of the client data and their outcomes, and/or the manner in which to contact one or more administrators. Such events may include component failures, instances of limits in capacity or bandwidth being reached or exceeded, changes in the configuration of storage volumes, installations or changes in components, changes in the manner in which components are coupled, etc. The collection server may poll one or more storage systems for such information on a recurring basis, and/or await transmission of such information to the collection server by one or more of the storage systems via a network. One or more of the storage systems may transmit such information to the collection server in response to the occurrence of one or more particular events as part of providing a record thereof to the administration system for subsequent diagnostics.

The storage systems from which the collection server receives such information may vary greatly in complexity and capability. By way of example, one or more of the storage systems may incorporate a single node providing a single controller of a relatively small quantity of storage devices that may or may not be operated together as an array of storage devices. Such relatively simple storage systems may incorporate relatively few hardware components and/or software components, and may simply be used as archival or “backup” storage for the client data stored within the client devices to guard against loss of client data should a malfunction of one of the client devices occur. As a result, the information transmitted by such a relatively simple storage system to the collection server may correspondingly be relatively simple in content. Also such information may be transmitted relatively infrequently or in response to a change in the components and/or configuration of the storage system.

Alternatively and also by way of example, one or more of the storage systems may incorporate multiple nodes and/or numerous storage devices. Multiple sets of the storage devices may be operated together as fault-tolerant arrays on which client data may be stored in a fault-tolerant manner that prevents loss of client data in the event of a malfunction of one of the storage devices. Also, two or more of the multiple nodes may be interconnected to form high-availability (HA) groups of nodes to support redundancy among the controllers provided by each of the nodes in which one node may take over for the other in the event of a failure of a node. Further, the multiple nodes and multiple storage devices may be divided into clusters that may be installed at geographically distant locations, but may be interconnected in a manner in which the state of the client data stored within the storage devices of one cluster may be mirrored in the state of the client data stored within the storage devices of another cluster. As a result, the information transmitted by such a relatively complex storage system to the collection server may correspondingly be relatively complex in content. Also such information may be transmitted relatively frequently on a timed basis and/or in response to changes in the components and/or configuration of the storage system, as well as in response to various events such as a takeover between nodes or other automated resolution to a detected problem.

In various embodiments, the operator of the administration system may be a purveyor of the storage systems from which the collection server receives such information, such as a manufacturer, distributor, reseller, installer and/or repairer of those storage systems. Thus, each of the operators of one or more of those storage systems may be a customer of such a purveyor, and so each of the operators of one or more of those storage systems may be deemed an account of the operator of the administration system. Each of those storage system operators may be a corporate, governmental, non-profit or other entity that employs one or more of such storage systems for use in storing their own data. Alternatively or additionally, each of those storage system operators may be a corporate, governmental, non-profit or other entity that operates one or more of such storage systems to provide storage services and/or other services that require storage to a multitude of end users of those services. As part of operating one or more of such storage systems, each of those storage system operators may employ or otherwise engage the services of one or more administrators to oversee the operation thereof. Those administrators may be responsible for allocating available storage resources, maintenance, security, performing upgrade and/or diagnosing failures. Also, the operator of the administration system may similarly employ or otherwise engage the services of one or more assisting administrators to assist the administrators associated with the storage system operators. Indeed, each of such assisting administrators may be assigned a particular subset of the storage system operators to which they are to provide such assistance.

Thus, the collection server may organize the account database to include a separate account entry for each operator of one or more storage systems from which the collection server receives information. For each storage system operator that operates more than one storage system, the collection server may further organize each of their associated account entries into multiple system entries that each correspond to one of their storage systems. As information is received from each of the storage systems, that information may be stored within the account entry and/or a separate system entry associated with the operator of that storage system and/or associated with that one of multiple storage systems operated by that operator.

The enrollment server may access the data stored within each of the account entries and/or system entries of the account database on a recurring basis to determine current topics of interest to the administrators of each storage system operator. The enrollment server may maintain tag data made up of a list of topics that each of a set of documents may be tagged as addressing. The tag data may also, for each topic of the list of topics, include criterion by which a determination may be made as to whether that topic is a topic of interest. As the enrollment server accesses each account entry and/or system entry of the account database, the enrollment server may iterate through the list of topics of the tag data and may employ the criterion associated with each of the topics to determine which of those topics are a topic of interest to the administrator(s) of the storage system operator associated with that entry based on the received information stored within that entry. Such criterion may include conditions such as whether a particular hardware or software component is present within a storage system, whether one or more particular features of a component are enabled and/or disabled, whether a particular type of event has occurred within a storage system, whether at least a portion of the storage space provided by a storage system is used for a particular application, whether a particular type of data is stored within a storage system, etc. It should be noted that more than one of these and/or other criteria may be employed in a determination of whether a topic is a topic of interest.

The enrollment server may also maintain threshold data made up of at least indications of thresholds that may be employed along with the criterion specified in the tag data for determining whether a topic listed in the tag data is a topic of interest. By way of example, the fact that a storage system includes a particular component and/or that a particular feature of that component is enabled may not be deemed to be enough to indicate that the component and/or the feature is a topic of interest. Instead, the threshold data may specify a minimum degree of usage of that component and/or that feature that must be met for that component and/or that feature to be deemed a topic of interest. This may be done to prevent a false determination that the component and/or feature is a topic of interest where an administrator may have only installed that component and/or used that feature on a temporary basis to simply test or try out that component and/or feature.

The enrollment server may also maintain timing data made up of at least indications of lifespans and/or scheduled end-of-life (EOL) dates of particular hardware and/or software components that may be employed along with the criterion specified in the tag data for determining whether a topic listed in the tag data is a topic of interest. By way of example, the fact that a storage system includes a particular component that has a limited lifespan (e.g., a battery) may be enough to indicate that the replacing of that component has become a topic of interest. Indeed, such timing data may be used in conjunction with the threshold data, where the threshold data may specify a threshold number of days, weeks or months ahead of when the end of the lifespan is reached as the time at which the replacing of that component becomes a topic of interest.

In response to determining that a topic has become a topic of interest to the administrator(s) of a storage device operator, the enrollment server may automatically enroll those administrators in a news feed associated with that topic of interest. However, it should be noted that in addition to determining that a topic has become a topic of interest, the enrollment server may also determine that a topic that was previously at topic of interest has ceased to be a topic of interest. This may arise where a component that was previously part of a storage system has been removed from that storage system and/or where a feature of a component that was previously enabled has been disabled. In response to determining that a topic of interest has ceased to be a topic of interest to the administrator(s) of a storage device operator, the enrollment server may automatically undo the enrollment of those administrators in a news feed associated with that topic of interest.

Upon determining what news feeds in which to enroll and/or undo the enrollment of the administrators associated with each storage device operator, the enrollment server may then store the current enrollments of those administrators within an enrollment database. The enrollment server may organize the enrollment database into multiple enrollment entries in which each enrollment entry corresponds to an account entry of the account database maintained by the collection server.

A documentation server may store and maintain a documents database made up of numerous documents that have each been tagged with one or more tags indicating the applicability of the contents of that document to one or more topics of interest. The documentation server may receive the documents from one or more authoring devices by which each of the documents may have been created. In some embodiments, at least a subset of the documents received by the documentation server may have already been tagged during their creation. However, in other embodiments, the documentation server may automatically tag at least a subset of the documents based on an analysis of their contents. More specifically, the documentation server may maintain a version of the tag data maintained by the enrollment server in which each of the topics of the list of topics therein is accompanied by criterion by which a determination may be made as to whether that topic is a topic of a document. The documentation server may examine each received document, and in so doing, may iterate through the list of topics of the tag data and employ the criterion associated with each of the listed topics to determine which of those topics are sufficiently a subject of focus of the contents of the document such that the document is to be tagged with a tag indicating so.

The documents may each take any of a variety of forms that may be transmitted by the distribution server to the administration devices via a network, including and not limited to, text, still images, audio presentations, motion video that may or may not be accompanied by audio, and/or a combination of thereof. By way of example, the documents may include a single page of text and/or still images explaining various features of a component of a storage system, an entire operating manual, an audio/visual presentation of installing and/or configuring a component, a diagnostics checklist organized as an interactive tree of pages, or a survey concerning the experience of installing and/or operating a component. It should also be noted that the news feeds into which administrators of different storage device operators may be enrolled may encompass relatively simple one-way communications in the form of documents transmitted to administration devices, or may encompass two-way communications channels formed between administration devices associated with different operators of different storage systems associated with different accounts where the administrators have been enrolled into the same news feed. Stated differently, enrollment in a news feed by the enrollment server may enable participation in a forum, web blog, or other form of shared online communications associated with a particular topic of interest between administrators of different entities that operate storage systems.

The distribution server may, on a recurring basis, access the enrollment database maintained by the enrollment server and the documents database maintained by the documentation server to determine what documents to transmit to one or more administrators overseeing one or more of the storage systems that provide information to the collection server. More specifically, the distribution server may recurringly compare the indications of topics of interest for each enrollment entry of the enrollment database to the tags of documents recently added to the documents database, and may select one or more of those recently added documents to transmit to the administration devices of the administrators associated with that enrollment entry based on the results of those comparisons. Thus, for example, where a storage system operated by a particular operator includes a particular hardware component, the fact of the inclusion of that hardware component within that storage system may be reflected in the account entry associated with that operator, and may thereby cause the administrator(s) of that operator to be enrolled in a news feed associated with that particular hardware component as a topic of interest. As a result, upon the addition of a new document to the documents database that has been tagged with an indication that the contents thereof address that particular hardware component as a topic of that document, the distribution server may select that document to transmit to the administrator(s) of that particular operator as a result of their enrollment in that news feed.

The distribution server may also maintain correlation data that correlates particular assisting administrators of the operator of the administration system to one or more operators of storage systems and the administrators associated therewith. As previously discussed, an assisting administrator may be assigned to provide assistance to administrators of one or more particular operators of storage systems associated with one or more particular accounts. As part of facilitating the provision of such assistance, the distribution server may transmit to such an assisting administrator the same documents that it transmits to the administrators of each of the storage system operators to which that assisting administrator is assigned to provide assistance.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

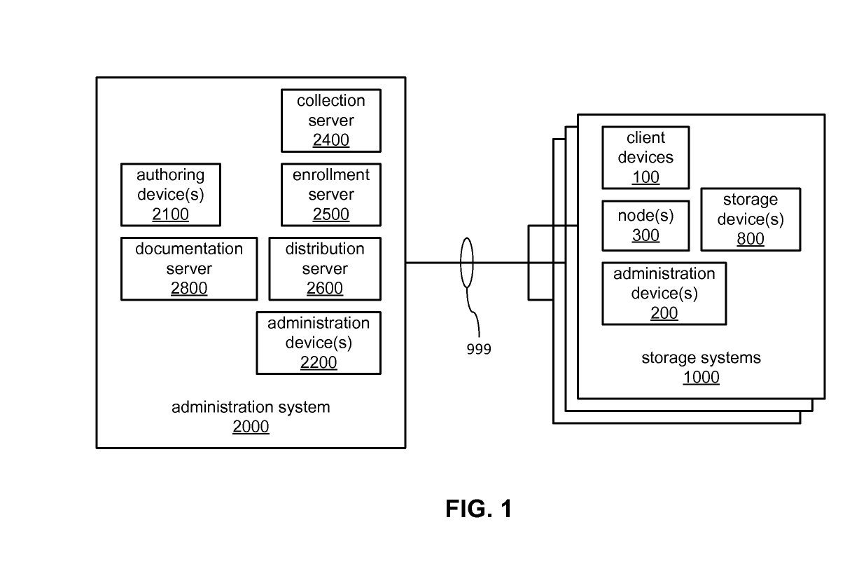

FIG. 1 illustrates a block diagram of an example embodiment of an administration system 2000 interacting with multiple storage systems 1000 via a network 999. As depicted, the administration system 2000 may incorporate one or more authoring devices 2100, one or more administration devices 2200, a collection server 2400, an enrollment server 2500, a distribution server 2600 and/or a documentation server 2800. As also depicted, each of the storage systems 1000 may incorporate one or more client devices 100, an administration device 200, one or more nodes 300 and/or one or more storage devices 800. As further depicted, and as will be discussed in greater detail, one or more of the devices of each of the storage systems 1000 may exchange data with one or more of the devices of the administration system 2000 via the network 999. The network 999 may be a single network limited to extending within a single building or other relatively limited area, may include a combination of connected networks extending a considerable distance, and/or may include the Internet.

Within each of the storage systems 1000, the one or more nodes 300 may control the one or more storage devices 800 to store client data received from the one or more client devices. The one or more administration devices 200 may be operated by administrator(s) to configure aspects of the operation of the one or more nodes 300 and/or to configure aspects of the manner in which the client data is stored within the one or more storage devices 800. On a recurring basis, at least one of the nodes 300 of each of the storage systems 1000 may transmit various pieces of information concerning the configuration and operation of that one of the storage systems 1000 to the collection server 2400 of the administration system 2000. Also on a recurring basis, the one or more administration devices 200 of each of the storage systems 1000 may receive various documents providing information concerning the configuration and operation of that one of the storage systems 1000 from the documentation server 2800.

Within the administration system 2000, the collection server 2400 may store and organize the information received from at least one node 300 of each of the storage systems 1000. The enrollment server 2500 may recurringly access and analyze that stored information to recurringly determine topics of interest to the administrator(s) overseeing each of the storage systems 1000, and may enroll those administrators in one or more news feeds that are each associated with one of those topics of interest. The documentation server 2800 may store a database of documents that may be generated by operator(s) of the one or more authoring devices 2100. Each of those documents may be tagged with one or more tags indicating applicability of that document to one or more topics of interest. On a recurring basis, the distribution server 2600 may access indications of enrollments maintained by the enrollment server 2500 and the database of documents maintained by the documentation server 2800 to identify at least recently added documents to be transmitted and administrators enrolled in one or more news feeds to transmit the documents to. However, the distribution server 2600 may also transmit those same documents to particular assisting administrator(s) assigned to provide assistance to the particular administrators who are also receiving those documents. Such transmission of such documents may be made by the distribution server 2600 to the one or more administration devices 200 associated with the identified ones of the administrators within the storage systems 1000, and to appropriate ones of the one or more administration devices 220 associated with appropriate assisting administrator(s).

In various embodiments, the operator of the administration system 2000 may be a purveyor of the storage systems 1000 from which the collection server 2400 receives such information, such as a manufacturer, distributor, reseller, installer and/or repairer of those storage systems. Thus, each of the operators of one or more of those storage systems 1000 may be a customer of such a purveyor. Each of those storage system operators may be a corporate, governmental, non-profit or other entity that employs one or more of such storage systems for use in storing their own data. Alternatively or additionally, each of those storage system operators may operate one or more of such storage systems to provide storage services and/or other services that require storage to a multitude of end users of those services. As part of operating one or more of such storage systems, each of those storage system operators may employ or otherwise engage the services of the one or more administrators to oversee the operation thereof through operation of the one or more administration devices 200 of each of the storage systems 1000. Also, the operator of the administration system 2000 may similarly employ or otherwise engage the services of the one or more assisting administrators to assist the administrators associated with the storage system operators.

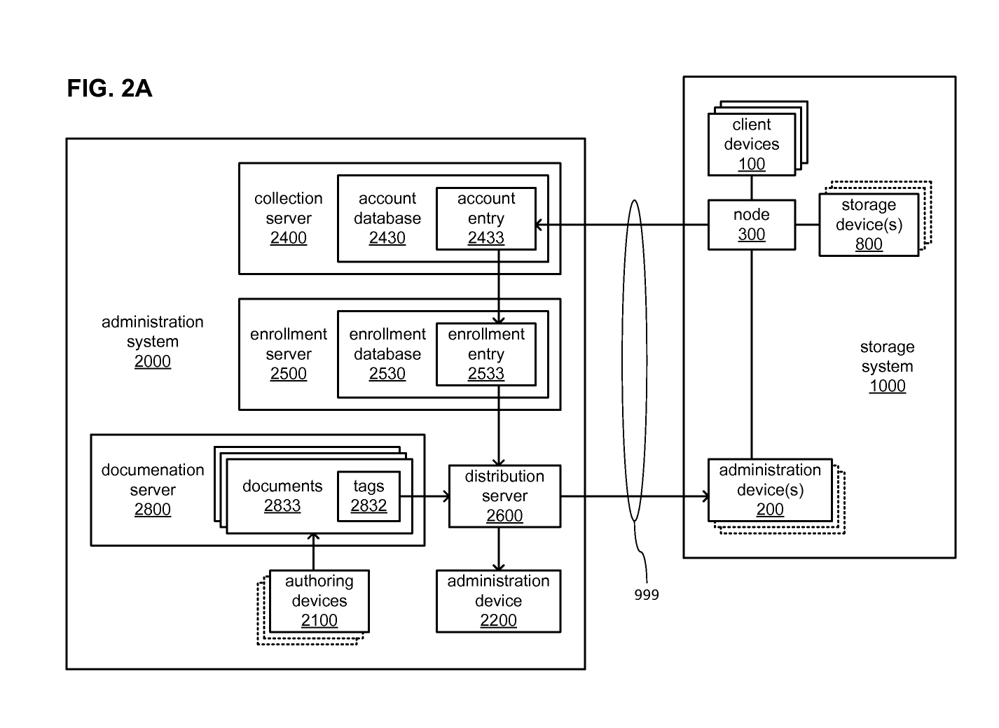

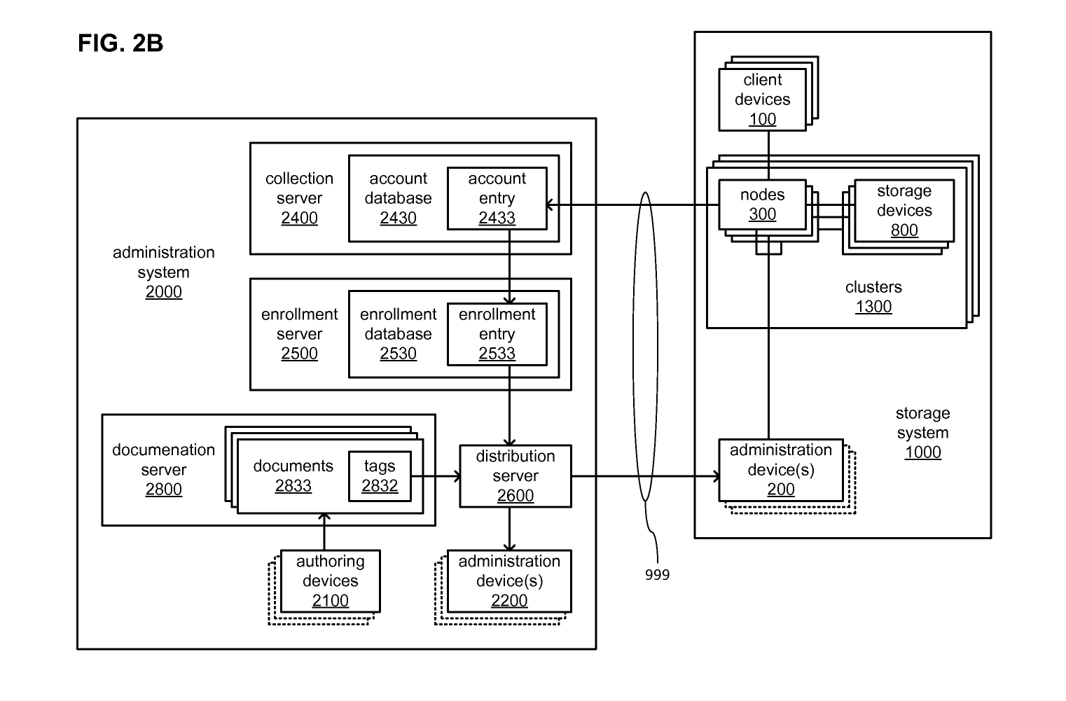

FIGS. 2A and 2B each illustrate a block diagram of the administration system 2000 interacting with a storage system 1000 through the network 999 in greater detail. In FIG. 2A, the administration system 2000 may interact with a relatively simple embodiment of the storage system 1000 that incorporates a single node 300 that controls the one or more storage devices 800. In FIG. 2B, the administration system 2000 may interact with a relatively complex embodiment of the storage system 1000 that incorporates multiple ones of the nodes 300 and of the storage devices 800 that may be organized into multiple clusters 1300 in which the manner in which client data is stored within one set of the storage devices 800 is mirrored within another set of the storage devices 800 at what may be geographically distant locations to increase fault tolerance.

As depicted, and regardless of the degree of complexity of any of the multiple storage systems 1000 with which the administration system 2000 interacts, the information received by the collection server 2400 from one of the nodes 300 of each of the storage systems 1000 is stored within an account entry 2433 associated with an operator of one or more of the storage systems 1000. For each such operator, a separate account entry 2433 is defined within an account database 2430 maintained by the collection server 2400, and each account entry 2433 may include the information received from all of the storage systems 1000 operated by a single such operator.

The enrollment server 2500 recurringly accesses each of the account entries 2433 to determine the topics of interest to the administrator(s) of the storage system operator associated with that account entry 2433, and enrolls the administrator(s) of that storage system operator into one or more news feeds based on those topics of interest. The enrollment server 2500 stores indications of the enrollments made for the administrator(s) of each storage system operator in a separate enrollment entry 2533 or an enrollment database 2530 maintained by the enrollment server 2500.

The documentation server 2800 stores documents 2833 that it may receive from the one or more authoring devices 2100 and that may each be tagged with one or more tags 2832 indicating topics addressed therein. The distribution server 2600 may recurringly determine which ones of the documents 2833 to transmit to the one or more administration devices 200 within each of the storage systems 1000 and/or the one or more administration devices 2200 of the administration system 2000 based on indications of enrollments in the enrollment entries 2533 and on the one or more tags 2832 within each of the documents 2833.

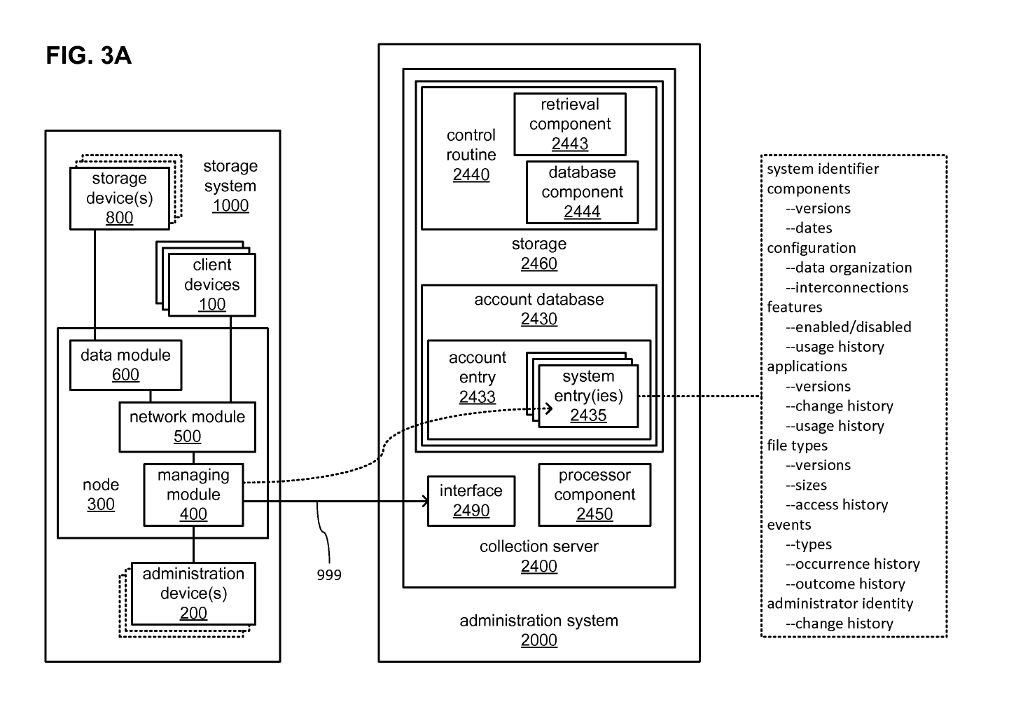

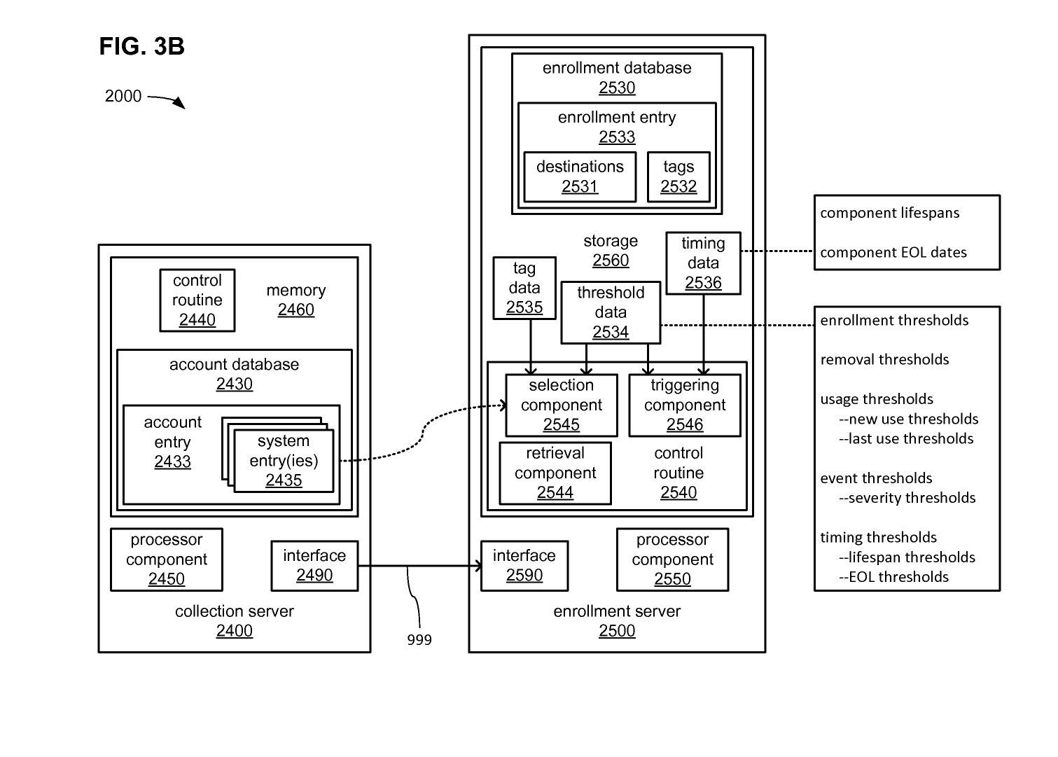

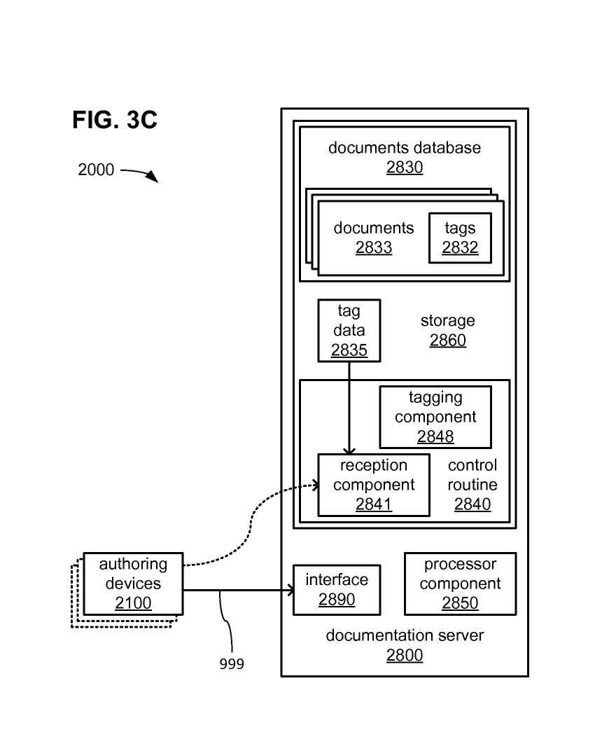

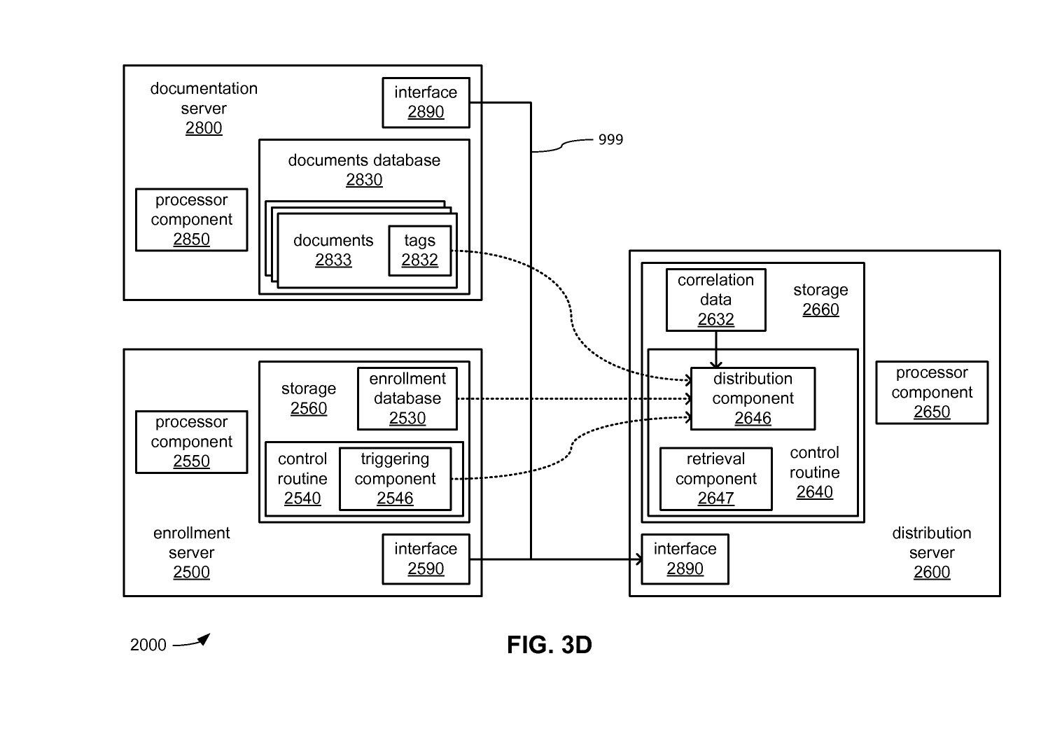

FIGS. 3A-D each illustrate a block diagram of a portion of an embodiment of the administration system 2000 of FIG. 1 in greater detail. More specifically, FIG. 3A depicts aspects of the operating environment of an example embodiment of the collection server 2400, FIG. 3B depicts aspects of the operating environment of an example embodiment of the enrollment server 2500, FIG. 3C depicts aspects of the operating environment of an example embodiment of the documentation server 2800, and FIG. 3D depicts aspects of the operating environment of an example embodiment of the distribution server 2600.

Turning to FIG. 3A, in various embodiments, the collection server 2400 incorporates one or more of a processor component 2450, a storage 2460 and an interface 2490 to couple the collection server 2400 to at least the network 999. The storage 2460 may store the account database 2430 and a control routine 2440. The account database 2430 may be made up of numerous ones of the account entries 2433, and each of the account entries 2433 may include one or more system entries 2435. The control routine 2440 may incorporate a sequence of instructions operative on the processor component 2450 in its role as a main processor component of the collection server 2400 to implement logic to perform various functions during execution of the control routine 2440 by the processor component 2450.

As depicted, the control routine 2440 may incorporate a retrieval component 2443 executable by the processor component 2450 to operate the interface 2490 to receive information concerning the configuration and operating aspects of the one or more storage systems 1000 from at least one node 300 of each. As depicted, the at least one node 300 of each of the storage systems 1000 may incorporate a data module 600 to serve as a controller of the one or more storage devices 800 of that storage system 1000, a network module 500 to monitor the performance of storage requests received from the one or more client devices 100, and a managing module 400 by which the at least one node 300 may be configured. As also depicted, it may be the Managing module 400 of the at least one node 300 of each of the storage systems 1000 that transmits the information concerning configuration and aspects of operation. As previously discussed, each of the storage systems 1000 may vary greatly in complexity from relatively simple embodiments that incorporate only a single node 300 and as few as a single storage device 800, to relatively complex embodiments that incorporate multiple nodes 300 and numerous storage devices 800 coupled and configured to provide multiple forms of fault tolerance.

The retrieval component 2443 may operate the interface 2490 to recurringly contact the at least one node 300 of one or more of the storage systems 1000 via the network 999 to poll for such information on what may be regular intervals. Alternatively or additionally, the retrieval component 2443 may operate the interface 2490 to await transmission of such information to the collection server 2400 by one or more of the storage systems 1000. Again, one or more of the storage systems 1000 may transmit such information to the collection server 2400 at a recurring interval of time and/or in response to the occurrence of one or more particular events as part of providing the collection server 2400 with a record thereof for subsequent diagnostics.

The information so collected from each of the storage systems 1000 may include indications of various aspects of the hardware and/or software components that make up each of the storage systems 1000, such as versions of those components and/or dates of manufacture of those components. Such information may include indications of the manner in which various aspects of each of the storage systems 1000 are configured, such as the manner in which various hardware components thereof are coupled and/or the manner in which client data and/or other data are organized as stored within one or more of the storage devices 800. Such information may include indications of features of each of the storage systems 1000 that are enabled and/or disabled, as well as features of individual hardware and/or software components, and as well as indications of the manner in which one or more of those features are configured. Such information may include indications of what applications software is used with each of the storage systems 1000, including versions of those applications, histories of changes in what applications are used, and/or histories of the pattern and/or degree of usage of each of those applications. Such information may include indications of the kind of client data stored within one or more of the storage devices 800 of each of the storage systems 1000, including types of data files, versions of the file types that are used, the sizes of various types of data files, and/or the pattern and/or frequency of accesses made to various types of data files. Such information may include indications of occurrences of various events within or otherwise involving each of the storage systems 1000, including types of events (e.g., malfunctions, instances of exceeding storage capacity, resizing of volumes, additions and/or removals of storage devices 800, etc.), the outcomes of various events, and/or the pattern and/or frequency of occurrence of various types of events. Such information may include identities and/or contact information for one or more administrators associated with an operator of one or more of the storage systems 1000 (e.g., a network address of one of the administration devices 200 that is associated with one or more of those administrators).

As also depicted, the control routine 2440 may incorporate a database component 2444 executable by the processor component 2450 to organize and store such information as is received from the at least one node 300 of each of the storage systems 1000 in the account database 2430. As previously discussed, the account database 2430 may be divided into multiple account entries 2433 with each of the account entries 2433 storing all of such information received from one or more storage systems 1000 that are operated by a single storage system operator. As also previously discussed, where a single storage system operator operates multiple ones of the storage systems 1000, the information received from each may be stored in separate system entries 2435 defined within the account entry 2433 associated with that storage system operator.

Turning to FIG. 3B, in various embodiments, the enrollment server 2500 incorporates one or more of a processor component 2550, a storage 2560 and an interface 2590 to couple the enrollment server 2500 to at least the network 999. The storage 2560 may store the enrollment database 2530, threshold data 2534, tag data 2535, timing data 2536 and a control routine 2540. The enrollment database 2530 may be made up of numerous ones of the enrollment entries 2533, and each of the enrollment entries 2533 may include destination data 2531 and/or one or more tags 2532. The control routine 2540 may incorporate a sequence of instructions operative on the processor component 2550 in its role as a main processor component of the enrollment server 2500 to implement logic to perform various functions during execution of the control routine 2540 by the processor component 2550.

The tag data 2535 may include a list of topics that may potentially be of interest to administrators of an operator of one or more of the storage systems 1000, along with criterion for determining whether each of those topics is a topic of interest. Such criterion may include whether a particular hardware and/or software component is included within one of the storage systems 1000, whether a particular feature is enabled, whether two or more hardware components are coupled in a particular manner within one of the storage systems 1000, whether one of the storage systems 1000 is used to store client data for a particular application, whether a particular type of data file is stored within one or more storage devices 800, whether a particular type of event has occurred, etc.

The threshold data 2534 may include indications of one or more thresholds that may be used to modify the criterion in the tag data 2535 for determining whether one or more of the topics listed therein is a topic of interest. By way of example, where usage of a component or feature may determine whether a topic is a topic of interest, the threshold data 2534 may include an indication of a minimum degree of usage of that component or that feature in making that determination. Such use of such a threshold may be deemed desirable to prevent a single occasion of an accidental or unintended use of that component or that feature from leading to a false determination that a topic listed in the tag data 2535 is a topic of interest.

The timing data 2536 may include indications of one or more lengths of time and/or one or more dates that may be used to modify the criterion in the tag data 2535 for determining whether one or more of the topics listed therein is a topic of interest. Such lengths of time may include lifespans of particular hardware components (e.g., batteries), and may be employed as part of determining that the topic of how to replace an aging component or what new component to replace an aging component with has become a topic of interest as the end of the lifespan of that component approaches. Such dates may include dates on which some form of support for the continued use of various components and/or features are to end (e.g., so called “end-of-life” or EOL dates), and may be employed as part of determining that the topic of what new component to replace an older component with or how to migrate to a new feature that replaces an older feature has become a topic of interest.

As depicted, the control routine 2540 may incorporate a retrieval component 2544 executable by the processor component 2550 to operate the interface 2590 to recurringly access the account entries 2433 of the account database 2430 maintained by the collection server 2400. The retrieval component 2544 may operate the interface 2590 to recurringly contact the collection server 2400 via the network 999 to poll for the contents of each of the account entries 2433 on what may be a regular interval. Alternatively or additionally, the retrieval component 2544 may operate the interface 2590 to await transmission of the contents of each of the account entries 2433 by the collection server 2400, which may transmit such contents to the enrollment server 2500 at a recurring interval of time and/or in response to the occurrence of one or more particular changes to the contents of one of the account entries 2433.

As also depicted, the control routine 2540 may incorporate a selection component 2545 executable by the processor component 2550 to analyze the received contents of each account entry 2433 to determine current topics of interest to the administrators of the storage system operator associated with that account entry 2433. In so analyzing the contents of each account entry 2433, the selection component 2545 may iterate through the topics listed within the tag data 2535, and determine whether the criterion within the tag data 2535 for each topic is currently met for that topic to be a topic of interest. Also in so doing, the selection component 2545 may additionally employ any thresholds specified in the threshold data for that topic, and/or may additionally apply any durations of time and/or dates specified in the timing data for that topic along with the specified criterion for that topic.

The selection component 2545 may store indications of what topics are determined to be topics of interest for the administrator(s) of each storage system operator as the one or more tags 2532 in a corresponding one of the enrollment entries 2533 of the enrollment database 2530. In some embodiments, there may be a single enrollment entry 2533 for each operator of one or more of the storage systems 1000 such that there may be a one-to-one correspondence of the enrollment entries 2533 of the enrollment database 2530 to the account entries 2433 of the account database 2430 maintained by the collection server 2400. The storing of a tag 2532 indicating that a topic is a topic of interest within one of the enrollment entries 2533 may, itself, serve to enroll the administrator(s) of the storage system operator associated with that enrollment entry 2533 in a news feed that is associated with that topic. More precisely, and as will shortly be explained, the distribution server may rely on the presence and/or absence of such tags 2532 within each of the enrollment entries 2533 as an indication of what topics are the topics of interest to the administrator(s) of the storage system operator associated with that enrollment entry 2533.

Again, it should be noted that in addition to determining that a topic has become a topic of interest to the administrator(s) of a particular storage system operator, the selection component 2545 may also determine that a topic that was previously of interest has ceased to be a topic of interest. This may arise where a component that was previously a part of a storage system operated by that operator has been removed from that storage system and/or where a feature of a component that was previously enabled has been disabled. In response to determining that a topic has ceased to be a topic of interest, the selection component 2545 may remove a tag 2532 associated with that topic from the enrollment entry 2533 associated with that storage system operator.

As further depicted, the control routine 2540 may incorporate a triggering component 2546 executable by the processor component 2550 to transmit an indication to the distribution server 2600 of instances in which the administrator(s) of an storage system operator has been newly enrolled in a news feed and/or has been newly removed from enrollment in a news feed. As will be explained in greater detail, it may be deemed desirable to transmit such indications to the distribution server 2600 to trigger the transmission of particular documents associated with a particular topic of interest by the distribution server 2600 in response to a new enrollment and/or in response to a new cessation of an enrollment.

Turning to FIG. 3C, in various embodiments, the documentation server 2800 incorporates one or more of a processor component 2850, a storage 2860 and an interface 2890 to couple the documentation server 2800 to at least the network 999. The storage 2860 may store the documents database 2830, tag data 2835 and a control routine 2840. The documents database 2830 may be made up of numerous ones of the documents 2833, each of which may be tagged by one or more of tags 2832. The control routine 2840 may incorporate a sequence of instructions operative on the processor component 2850 in its role as a main processor component of the documentation server 2800 to implement logic to perform various functions during execution of the control routine 2840 by the processor component 2850.

The tag data 2835 may include a list of topics with which each of the documents 2833 may be tagged as addressing as a subject, along with criterion for determining whether each of those topics is a subject of each of the documents 2833. Such criterion may include whether the topic appears in a particular portion of one the documents 2833, a minimum number of times the topic is referred to, etc.

As depicted, the control routine 2840 may incorporate a reception component 2841 executable by the processor component 2850 to operate the interface 2890 to receive the documents 2833 from the one or more authoring devices 2100. The reception component 2841 may also organize the documents 2833 within the documents database 2830 such that they may be subsequently retrieved for further editing, etc. In some embodiments, the reception component 2841 may enforce some degree of control over subsequent accesses to the documents 2833 to prevent accidental erasures of the documents 2833 and/or to prevent instances of conflicting edits made to the documents 2833 by operators of more than one of the authoring devices 2100.

As also depicted, the control routine 2840 may incorporate a tagging component 2848 executable by the processor component 2850 to analyze each of the documents to determine topics that are the subject of each of the documents 2833. In so analyzing each document 2833, the tagging component 2848 may iterate through the topics listed within the tag data 2835, and determine whether the criterion within the tag data 2835 for each topic is currently met for that topic to be a subject of that document 2833.

The tagging component 2848 may tag each document 2833 with one or more of the tags 2832 that indicate what topic(s) are determined to be the subject(s) of that document 2833. In some embodiments, such tagging may entail augmenting each document 2833 with additional data that encodes indications of what topic(s) are determined to be the subject(s) of that document. In other embodiments, an entry (not shown) may be generated in the documents database 2830 for each of the documents 2833 in which indications may be stored of what topic(s) are the subject(s) of that document 2833.

Turning to FIG. 3D, in various embodiments, the distribution server 2600 incorporates one or more of a processor component 2650, a storage 2660 and an interface 2690 to couple the distribution server 2600 to at least the network 999. The storage 2660 may store correlation data 2632 and a control routine 2640. The control routine 2640 may incorporate a sequence of instructions operative on the processor component 2650 in its role as a main processor component of the distribution server 2600 to implement logic to perform various functions during execution of the control routine 2640 by the processor component 2650.

The correlation data 2632 may include indications of which storage system operators are to be assisted by a particular one of what may be multiple assisting administrators of the operator of the administration system 2000. More precisely, each of what may be multiple assisting administrators of the operator of the administration system 2000 may be assigned to provide assistance to the one or more administrators of the operators of different ones of the storage systems 1000.

As depicted, the control routine 2640 may incorporate a retrieval component 2647 executable by the processor component 2650 to operate the interface 2690 to recurringly access the enrollment entries 2533 of the enrollment database 2530 maintained by the enrollment server 2500, and to recurring access the documents 2833 of the documents database 2830 maintained by the documents server 2800. The retrieval component 2647 may operate the interface 2690 to recurringly contact the enrollment server 2500 and/or the documentation server 2800 via the network 999 to poll for each. Alternatively or additionally, the retrieval component 2647 may operate the interface 2690 to await transmission of each by the enrollment server 2500 and the documentation server 2800.

As also depicted, the control routine 2640 may incorporate a distribution component 2646 executable by the processor component 2650 to analyze each of the enrollment entries 2533 and the tags 2832 of each of the documents 2833 to determine which ones of the documents 2833 most recently added to the documents database 2830 are to be transmitted to which ones of the administration devices 200. In so doing, the distribution component 2646 may recurringly compare the indications of topics of interest for each enrollment entry 2533 of the enrollment database 2530 to the topics indicated by the tags 2832 of each of the documents 2833 recently added to the documents database 2830, and may select one or more of those recently added documents 2833 to transmit to the administration devices 200 of the administrators associated with that enrollment entry 2533 based on the results of those comparisons. The distribution component 2646 may then use the indications of network addresses and/or other contact information included in that enrollment entry 2533 to transmit the selected one or more recently added documents 2833 to the administration devices 200 associated with the administrator(s) of the storage system operator associated with that enrollment entry 2533 as part of providing those administrator(s) with the services of the one or more news feeds in which they have been enrolled by the enrollment server 2500.

The distribution component 2646 may also employ the correlation data 2632 to determine which assisting administrator of the operator of the administration system 2000 is to receive the same one or more documents 2833 that are transmitted to the administrator(s) of one of the storage system operators they are assigned to support. Thus, in addition to transmitting one or more of the documents 2833 to the administration device(s) 200 of the administrator(s) of a storage system operator associated with a particular enrollment entry 2533, the distribution component 2646 may also transmit the same one or more of the documents 2833 to the administration device 2200 of the assisting administrator assigned to provide assistance to those administrator(s).

The distribution component 2646 may further receive indications from the triggering component 2546 of the enrollment server 2500 that indicate a new enrollment of one or more administrators or a new removal of one or more administrators from an enrollment. The distribution component 2646 may respond to such received indications by transmitting one or more particular documents to those administrators who have been newly enrolled or newly removed from enrollment. By way of example, in response to an indication that an administrator has been newly enrolled in a news feed associated with a particular topic of interest, the distribution component 2646 may transmit one or more particular documents 2833 that include a welcome notice to that administrator of their having been so enrolled and/or that includes some introductory material concerning that topic of interest. Also by way of example, in response to an indication that an administrator has been newly removed from being enrolled in a news feed associated with a particular topic of interest, the distribution component 2646 may transmit one or more particular documents 2833 that include a notice to that administrator of their having been so removed and/or that includes a survey requesting their input as to their impressions of the usefulness of having been enrolled in that news feed.

It should be noted that although FIG. 3A-D depict each of the servers 2400, 2500, 2600 and 2800 as separate and distinct computing devices with separate and distinct processor components and/or storages, other embodiments are possible in which two or more of the servers 2400, 2500, 2600 and 2800 may be combined within the same computing device. By way of example, a processor component of a single server may execute the instructions of both the control routines 2440 and 2540, or of both the control routines 2540 and 2640. Also by way of example, two or more of the servers 2400, 2500, 2600 and 2800 may be implemented as virtual machines generated within a single server by at least one processor component of that single server.

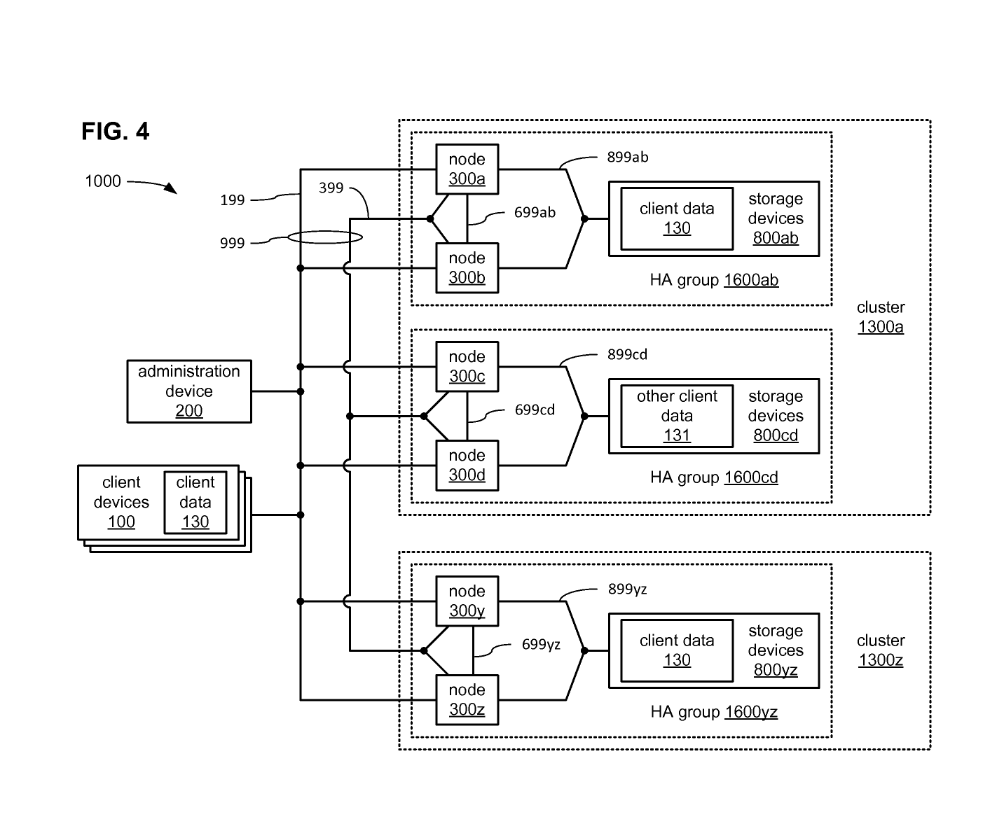

FIG. 4 illustrates a block diagram of an example embodiment of the storage system 1000 incorporating the one or more client devices 100, the one or more administration devices 200, and/or the one or more clusters 1300, such as the depicted clusters 1300a and 1300z. As depicted, the cluster 1300a may incorporate one or more of the nodes 300, such as the depicted nodes 300a-d, and one or more of the storage devices 800, such as the depicted sets of storage devices 800ab and 800cd. As also depicted, the cluster 1300z may incorporate more of the nodes 300, such as the depicted nodes 300y-z, and more of the storage devices 800, such as the depicted sets of storage devices 800yz. As further depicted, the cluster 1300a may include a HA group 1600ab incorporating the nodes 300a-b as partners and the set of storage devices 800ab. The cluster 1300a may also include a HA group 1600cd incorporating the nodes 300c-d as partners and the set of storage devices 800cd. Correspondingly, the cluster 1300z may include a HA group 1600yz incorporating the nodes 300y-z as partners and the set of storage devices 800yz. It should be noted that within the storage system 1000, each of the clusters 1300a and 1300z is an instance of a cluster 1300, each of the sets of storage devices 800ab, 800cd and 800yz represents one or more instances of a storage device 800, and each of the nodes 300a-d and 300y-z is an instance of the node 300 as earlier depicted and discussed in reference to FIGS. 1 and 2.

In some embodiments, the clusters 1300a and 1300z may be positioned at geographically distant locations to enable a degree of redundancy in storing and retrieving client data 130 provided by one or more of the client devices 100 for storage. Such positioning may be deemed desirable to enable continued access to the client data 130 by one or more of the client devices 100 and/or the administration device 200 despite a failure or other event that may render one or the other of the clusters 1300a or 1300z inaccessible thereto. As depicted, one or both of the clusters 1300a and 1300z may additionally store other client data 131 that may be entirely unrelated to the client data 130.

The formation of the HA group 1600ab with at least the two nodes 300a and 300b partnered to share access to the set of storage devices 800ab may enable a degree of fault tolerance in accessing the client data 130 as stored within the set of storage devices 800ab by enabling one of the nodes 300a-b in an inactive state to take over for its partner in an active state (e.g., the other of the nodes 300a-b) in response to an error condition within that active one of the nodes 300a-b. Correspondingly, the formation of the HA group 1600yz with at least the two nodes 300y and 300z partnered to share access to the set of storage devices 800yz may similarly enable a degree of fault tolerance in accessing the client data 130 as stored within the set of storage devices 800yz by similarly enabling one of the nodes 300y-z in an inactive state to similarly take over for its partner in active state (e.g., the other of the nodes 300y-z).

As depicted, any active one of the nodes 300a-d and 300y-z may be made accessible to the client devices 100 and/or the administration device 200 via a client interconnect 199. As also depicted, the nodes 300a-d and 300y-z may be additionally coupled via an inter-cluster interconnect 399. In some embodiments, the interconnects 199 and 399 may both extend through the same network 999. Each of the interconnects 199 and 399 may be implemented as virtual private networks (VPNs) defined using any of a variety of network security protocols through the network 999. Again, the network 999 may be a single network limited to extending within a single building or other relatively limited area, may include a combination of connected networks extending a considerable distance, and/or may include the Internet. As an alternative to coexisting within the same network 999, the interconnects 199 and 399 may be implemented as entirely physically separate networks. By way of example, the client interconnect 199 may extend through the Internet to enable the client devices 100 and/or the administration device 200 to be positioned at geographically diverse locations, while the inter-cluster interconnect 399 may extend through a leased line between the two geographically distant locations at which each of the clusters 1300a and 1300z are positioned.

As depicted, the partnered nodes within each of the HA groups 1600ab, 1600cd and 1600yz may be additionally coupled via HA interconnects 699ab, 699cd and 699yz, respectively. As also depicted, the nodes within each of the HA groups 1600ab, 1600cd and 1600yz may be coupled to the sets of storage devices 800ab, 800cd and 800yz in a manner enabling shared access via storage interconnects 899ab, 899cd and 899yz, respectively. The partnered nodes and set of storage devices making up each of the HA groups 1600ab, 1600cd and 1600yz may be positioned within relatively close physical proximity to each other such that the interconnects 699ab, 899ab, 699cd, 899cd, 699yz and 899yz may each traverse a relatively short distance (e.g., extending within a room and/or within a cabinet).

More broadly, one or more of the interconnects 199, 399, 699ab, 699cd and 699yz may be based on any of a variety (or combination) of communications technologies by which signals may be exchanged, including without limitation, wired technologies employing electrically and/or optically conductive cabling, and wireless technologies employing infrared, radio frequency or other forms of wireless transmission. Each of the interconnects 899ab, 899cd and 899yz may be based on any of a variety of widely known and used storage interface standards, including and not limited to, SCSI, serially-attached SCSI (SAS), Fibre Channel, etc.

It should be noted that despite the depiction of specific quantities of clusters and nodes within the storage system 1000, other embodiments are possible that incorporate different quantities of clusters and nodes. Similarly, despite the depiction of specific quantities of HA groups and nodes within each of the clusters 1300a and 1300z, other embodiments are possible that incorporate differing quantities of HA groups and nodes. Further, although each of the HA groups 1600ab, 1600cd and 1600yz is depicted as incorporating a pair of nodes 300a-b, 300c-d and 300y-z, respectively, other embodiments are possible in which one or more of the HA groups 1600ab, 1600cd and 1600yz may incorporate more than two nodes.

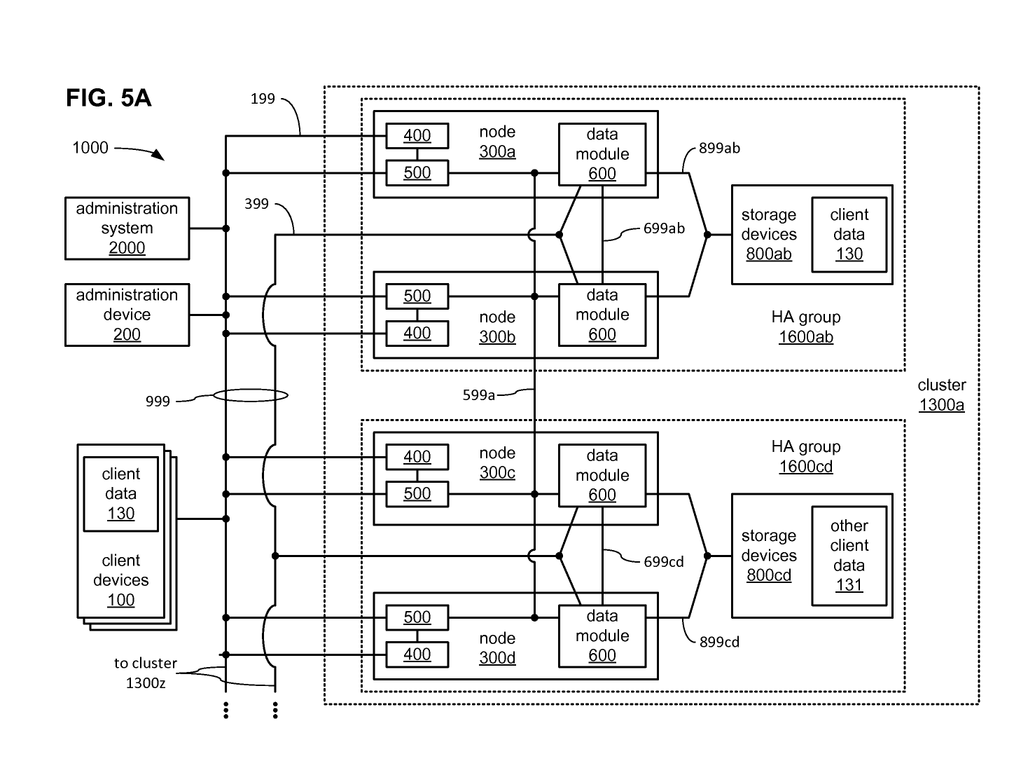

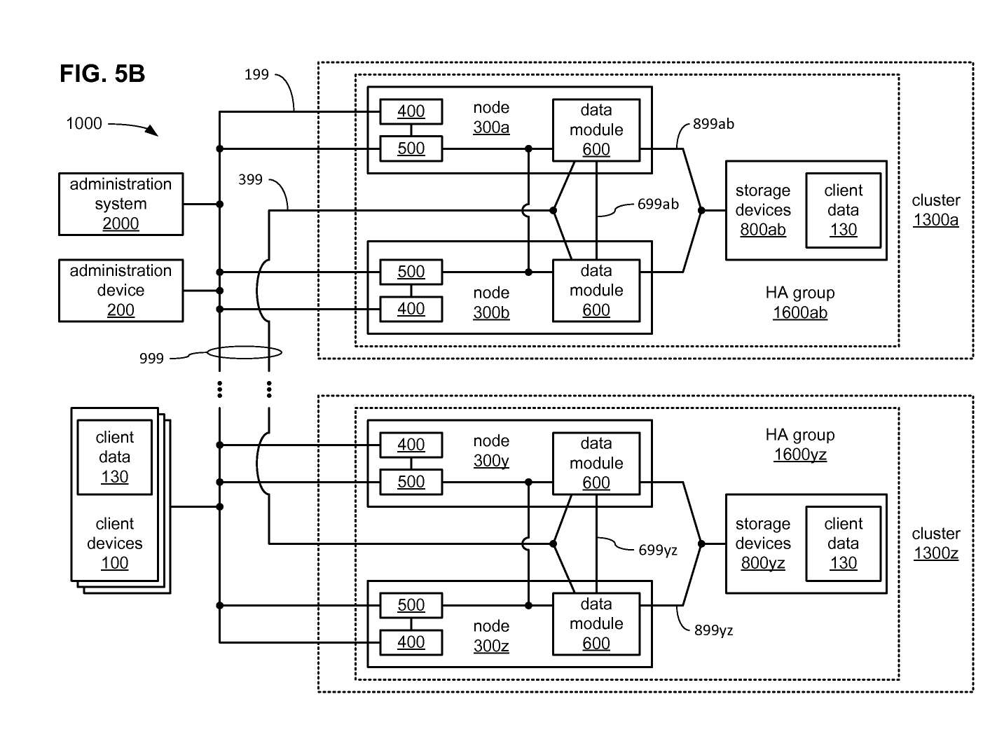

FIGS. 5A and 5B each illustrate a block diagram of an example portion of the embodiment of the storage system 1000 of FIG. 4 in greater detail. More specifically, FIG. 5A depicts aspects of the nodes 300a-d and interconnections thereamong within the cluster 1300a in greater detail. FIG. 5B depicts aspects of the interconnections among the nodes 300a-b and 300y-z, including interconnections extending between the clusters 1300a and 1300z, in greater detail.

Referring to both FIGS. 5A and 5B, each of the nodes 300a-d and 300y-z may incorporate one or more of a Managing module 400, a Network module 500 and a Data module 600. As depicted, each of the Managing modules 400 and the Network modules 500 may be coupled to the client interconnect 199, by which each may be accessible to one or more of the client devices 100, the administration device 200, and/or to the administration system 2000. The Managing module 400 of one or more active ones of the nodes 300a-d and 300y-z may cooperate with the administration device 200 via the client interconnect 199 to allow an operator of the administration device 200 to configure various aspects of the manner in which the storage system 1000 stores and provides access to the client data 130 provided by one or more of the client devices 100. That same Managing module 400 may also recurringly transmit indications of that configuration and other information concerning the storage system 1000 to the collection server 2400 of the administration system 2000. The Network module 500 of one or more active ones of the nodes 300a-d and 300y-z may receive and respond to requests for storage services received from one or more of the client devices 100 via the client interconnect 199, and may perform a protocol conversion to translate each storage service request into one or more data access commands.

As depicted, the Data modules 600 of all of the nodes 300a-d and 300y-z may be coupled to each other via the inter-cluster interconnect 399. Also, within each of the HA groups 1600ab, 1600cd and 1600yz, Data modules 600 of partnered nodes may share couplings to the sets of storage devices 800ab, 800cd and 800yz, respectively. More specifically, the Data modules 600 of the partnered nodes 300a and 300b may both be coupled to the set of storage devices 800ab via the storage interconnect 899ab, the Data modules 600 of the partnered nodes 300c and 300d may both be coupled to the set of storage devices 800cd via the storage interconnect 899cd, and the Data modules 600 of the partnered nodes 300y and 300z may both be coupled to the set of storage devices 800yz via the storage interconnect 899yz. The Data modules 600 of active ones of the nodes 300a-d and 300y-z may perform the data access commands derived by one or more of the Network modules 500 of these nodes from translating storage service requests received from one or more of the client devices 100.

Thus, the Data modules 600 of active ones of the nodes 300a-d and 300y-z may access corresponding ones of the sets of storage devices 800ab, 800cd and 800yz via corresponding ones of the storage interconnects 899ab, 899cd and 899yz to store and/or retrieve client data 130 as part of performing the data access commands. The data access commands may be accompanied by portions of the client data 130 to store and/or newer portions of the client data 130 with which to update the client data 130 as stored. Alternatively or additionally, the data access commands may specify portions of the client data 130 to be retrieved from storage for provision back to one or more of the client devices 100.

Further, and referring to FIG. 5B, the Data module 600 of an active one of the nodes 300a-b and 300y-z of one of the clusters 1300a or 1300z may replicate the data access commands and transmit the resulting replica data access commands via the inter-cluster interconnect 399 to another active one of the nodes 300a-b and 300y-z of the other of the clusters 1300a or 1300z to enable at least partial parallel performance of the data access commands by two of the Data modules 600. In this way, the state of the client data 130 as stored within one of the sets of storage devices 800ab or 800yz may be mirrored within the other of the sets of storage devices 800ab or 800yz, as depicted.

Such mirroring of the state of the client data 130 between multiple sets of storage devices associated with different clusters that may be geographically distant from each other may be deemed desirable to address the possibility of the nodes of one of the clusters becoming inaccessible as a result of a regional failure of the client interconnect 199 (e.g., as a result of a failure of a portion of the network 999 through which a portion of the client interconnect extends in a particular geographic region). As familiar to those skilled in the art, the use of additional interconnect(s) between partnered nodes of a HA group (e.g., the HA interconnects 699ab, 699cd and 699yz) tends to encourage physically locating partnered nodes of a HA group in close proximity to each other such that a localized failure of a network may render all nodes of a HA group inaccessible to the client devices 100. For example, a failure of a portion of a network that includes the client interconnect 199 in the vicinity of both of the nodes 300a and 300b may render both of the nodes 300a and 300b inaccessible to the client devices 100 such that the client data 130 stored within the sets of storage devices 800ab becomes inaccessible through either of the nodes 300a or 300b. With both of the sets of the storage devices 800ab and 800yz mirroring the state of the client data 130, the client devices 100 are still able to access the client data 130 within the set of storage devices 800yz, despite the loss of access to the set of storage devices 800ab.

Referring again to both FIGS. 5A and 5B, and as previously discussed, the sharing of access via the storage interconnects 899ab, 899cd and 899yz to each of the sets of storage devices 800ab, 800cd and 800yz, respectively, among partnered ones of the nodes 300a-d and 300y-z may enable continued access to one of the sets of storage devices 800ab, 800cd and 800yz in the event of a failure occurring within one of the nodes 300a-d and 300y-z. The coupling of Data modules 600 of partnered ones of the nodes 300a-d and 300y-z within each of the HA groups 1600ab, 1600cd and 1600yz via the HA interconnects 699ab, 699cd and 699yz, respectively, may enable such continued access in spite of such a failure. Through the HA interconnects 699ab, 699cd or 699yz, Data modules 600 of each of these nodes may each monitor the status of the Data modules 600 their partners. More specifically, the Data modules 600 of the partnered nodes 300a and 300b may monitor each other through the HA interconnect 699ab, the Data modules 600 of the partnered nodes 300c and 300d may monitor each other through the HA interconnect 699cd, and the Data modules 600 of the partnered nodes 300y and 300z may monitor each other through the HA interconnect 699yz.

Such monitoring may entail recurring exchanges of “heartbeat” and/or other status signals (e.g., messages conveying the current state of performance of a data access command) via one or more of the HA interconnects 699ab, 699cd or 699yz in which an instance of an absence of receipt of such a signal within a specified recurring interval may be taken as an indication of a failure of the one of the Data modules 600 from which the signal was expected. Alternatively or additionally, such monitoring may entail awaiting an indication from a monitored one of the Data modules 600 that a failure of another component of one of the nodes 300a-d or 300y-z has occurred, such as a failure of a Managing module 400 and/or of a Network module 500 of that one of the nodes 300a-d or 300y-z. In response to such an indication of failure of an active one of the nodes 300a-d or 300y-z belonging to one of the HA groups 1600ab, 1600cd or 1600yz, an inactive partner among the nodes 300a-d or 300y-z of the same one of the HA groups 1600ab, 1600cd or 1600yz may take over. Such a “takeover” between partnered ones of the nodes 300a-d or 300y-z may be a complete takeover inasmuch as the partner that is taking over may take over performance of all of the functions that were performed by the failing one of these nodes.

However, in some embodiments, at least the Network modules 500 and the Data modules 600 of multiple ones of the nodes 300a-d and/or 300y-z may be interconnected in a manner enabling a partial takeover in response to the failure of a portion of one of the nodes 300a-d or 300y-z. Referring more specifically to FIG. 5A, the Network modules 500 of each of the nodes 300a-d may be coupled to the Data modules 600 of each of the nodes 300a-d via an intra-cluster interconnect 599a. In other words, within the cluster 1300a, all of the Network modules 500 and all of the Data modules 600 may be coupled to enable data access commands to be exchanged between Network modules 500 and Data modules 600 of different ones of the nodes 300a-d. Thus, by way of example, where the Network module 500 of the node 300a has failed, but the Data module 600 of the node 300a is still operable, the Network module 500 of its partner node 300b (or of one of the nodes 300c or 300d with which the node 300a is not partnered in a HA group) may take over for the Network module 500 of the node 300a.

Although the clusters 1300a and 1300z may be geographically distant from each other, within each of the clusters 1300a and 1300z, nodes and/or components of nodes may be positioned within relatively close physical proximity to each other such that the intra-cluster interconnects 599a and 599z may each traverse a relatively short distance (e.g., extending within a room and/or within a single cabinet). More broadly, one or more of the intra-cluster interconnects 599a and 599z may be based on any of a variety (or combination) of communications technologies by which signals may be exchanged, including without limitation, wired technologies employing electrically and/or optically conductive cabling, and wireless technologies employing infrared, radio frequency or other forms of wireless transmission. By way of example, the intra-cluster interconnect 599a may be made up of a mesh of point-to-point interconnects coupling each Network module 500 of each of the nodes 300a-d to each Data module 600 of each of the nodes 300a-d. Alternatively, by way of another example, the intra-cluster interconnect 599a may include a network switch (not shown) to which each of the Network modules 500 and each of the Data modules 600 of the nodes 300a-d may be coupled.

The Managing module 400 of one or more of the active ones of the nodes 300a-d and 300y-z may recurringly retrieve indications of status from the Network modules 500 and/or Data modules 600 within the same node and/or from others of the nodes 300a-d and 300y-z. Where necessary, such a Managing module 400 may indirectly retrieve such information from one or more Network modules 500 and/or Data modules 600 through one or more other Managing modules 400. Among such retrieved indications may be indications of a failure in a Network module 500 and/or a Data module 600, and such a failure may have prompted a partial or a complete takeover by one of the nodes 300a-d and 300y-z of functions performed by another of the nodes 300a-d and 300y-z. Correspondingly, following a repair or other correction to address such a failure, the retrieved indications may include an indication of a “give-back” event in which a partial or complete takeover is reversed. In some embodiments, a Managing module 400 that recurringly retrieves such indications of status may recurringly transmit those indications to the collection server 2400 of the administration system 2000. Alternatively or additionally, that Managing module 400 may generate a summary or other form of aggregation of such events as takeovers and give-backs to transmit to the collection server 2400.

It should also be noted that despite the depiction of only a single one of each of the Managing module 400, the Network module 500 and the Data module 600 within each of the nodes 300a-d and 300y-z, other embodiments are possible that may incorporate different quantities of one or more of the Managing module 400, the Network module 500 and the Data module 600 within one or more of these nodes. By way of example, embodiments are possible in which one or more of the nodes 300a-d and/or 300y-z incorporate more than one Network module 500 to provide a degree of fault-tolerance within a node for communications with one or more of the client devices 100, and/or incorporate more than one Data module 600 to provide a degree of fault-tolerance within a node for accessing a corresponding one of the sets of storage devices 800ab, 800cd or 800yz.

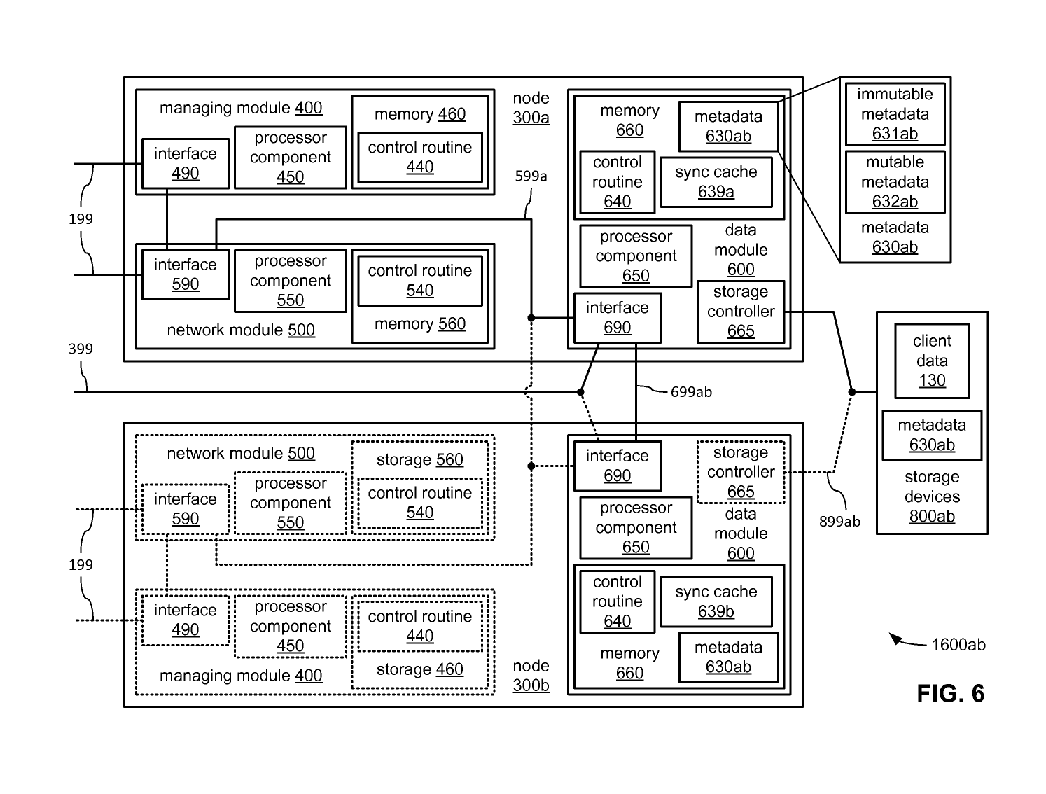

FIG. 6 illustrates a block diagram of an example embodiment of the HA group 1600ab of the cluster 1300a of the embodiment of the storage system 1000 of FIG. 4 in greater detail. As depicted, of the nodes 300a and 300b of the HA group 1600ab, the node 300a may be active to engage in communications with a client device 100 and/or the administration device 200, and may be active to perform operations altering the client data 130 within the set of storage devices 800ab, while the node 300b may be inactive and awaiting a need to take over for the node 300a. More specifically, the Managing module 400 and the Network module 500 of the node 300a may engage in communications with the client devices 100, the administration device 200 and/or the collection server 2400 of the administration system 2000 (as indicated with the Managing module 400 and the Network module 500 of the node 300a being drawn with solid lines), while the Managing module 400 and the Network module 500 of the node 300b may not (as indicated with the Managing module 400 and the Network module 500 being drawn with dotted lines).

In various embodiments, the Managing module 400 of each of the nodes 300a-b incorporates one or more of a processor component 450, a memory 460 and an interface 490 to couple the Managing module 400 to at least the client interconnect 199. The memory 460 may store a control routine 440. The control routine 440 may incorporate a sequence of instructions operative on the processor component 450 in its role as a main processor component of the Managing module 400 to implement logic to perform various functions. As a result of the node 300a being active to engage in communications with one or more of the client devices 100 and/or the administration device 200, the processor component 450 of the Managing module 400 of the node 300a may be active to execute the control routine 440. In contrast, as a result of the node 300b being inactive, the processor component 450 may not be active to execute the control routine 440 within the Managing module 400 of the node 300b. However, if the node 300b takes over for the node 300a, then the control routine 440 within the node 300b may begin to be executed, while the control routine 440 within the node 300a may cease to be executed.

In executing the control routine 440, the processor component 450 of the Managing module 400 of the active node 300a may operate the interface 490 to accept remotely supplied configuration data. In some embodiments, such remote configuration data may emanate from the administration device 200. By way of example, which one(s) of the nodes 300b-d or 300y-z may be partnered to form one or more HA groups (e.g., the HA groups 1600ab, 1600cd or 1600yz) may be remotely configured, as well as what nodes and/or HA groups may cooperate to provide further fault tolerance (e.g., geographically dispersed fault tolerance), what network addresses may be allocated to one or more of the nodes 300a-d and/or 300y-z on various interconnects, etc. In other embodiments, such remote configuration may emanate from one or more of the client devices 100. The processor component 450 may provide a web server, telnet access, instant messaging and/or other communications service(s) by which such aspects of operation may be remotely configured from the administration device 200 or one or more of the client devices 100 via the client interconnect 199. Regardless of the exact manner in which configuration information is remotely provided, as the processor component 450 receives such configuration information and/or subsequent to receiving such information, the processor component 450 may operate the interface 490 to relay it and/or updates thereto to the Network module 500 and/or the Data module 600 as a portion of metadata. Alternatively or additionally, the processor component 450 may also operate the interface 490 to relay such configuration information and/or updates thereto to the collection server 2400 of the administration system 2000.

In various embodiments, the Network module 500 of each of the nodes 300a-b incorporates one or more of a processor component 550, a memory 560 and an interface 590 to couple the Network module 500 to one or both of the client interconnect 199 and the intra-cluster interconnect 599a. The memory 560 may store a control routine 540. The control routine 540 may incorporate a sequence of instructions operative on the processor component 550 in its role as a main processor component of the Network module 500 to implement logic to perform various functions. As a result of the node 300a being active to engage in communications with one or more of the client devices 100 and to perform data access commands, the processor component 550 of the Network module 500 of the node 300a may be active to execute the control routine 540. In contrast, as a result of the node 300b being inactive, the processor component 550 may not be active to execute the control routine 540 within the N-module of the node 300b. However, if the node 300b takes over for the node 300a, then the control routine 540 within the node 300b may begin to be executed, while the control routine 540 within the node 300a may cease to be executed.

In executing the control routine 540, the processor component 550 of the Network module 500 of the active node 300a may operate the interface 590 to perform various tests to detect other devices with which to communicate and/or assign network addresses by which other devices may be contacted for communication. At least as part of rebooting following being reset or powered on, the processor component 550 may perform various tests on the client interconnect 199 and/or the intra-cluster interconnect 599a to determine addresses and/or communications protocols for communicating with one or more components (e.g., Managing modules 400, Network modules 500 and/or Data modules 600) of one or more of the nodes 300a-d and/or 300y-z. Alternatively or additionally, in embodiments in which at least a portion of the intra-cluster interconnect 599a supports internet protocol (IP) addressing, the processor component 550 may function in the role of a dynamic host control protocol (DHCP) server to assign such addresses. Also alternatively or additionally, the processor component 550 may receive configuration information from the Managing module 400 (e.g., a portion of metadata).

In some embodiments, configuration information received from the Managing module 400 may be employed by the processor component 550 in performing such tests on the client interconnect 199 and/or the intra-cluster interconnect 599a (e.g., the configuration information so received may include a range of IP addresses to be tested). As the processor component 550 performs such tests and/or subsequent to performing such tests, the processor component 550 may operate the interface 590 to relay indications of the results of those tests and/or updates thereto to the Data module 600 as a portion of metadata. Further, as the processor component 550 interacts with one or more of the client devices 100 and/or other devices, the processor component 550 may detect changes in information determined from the performance of various tests, and may operate the interface 590 to provide indications of those changes to the Data module 600 as portions of updated metadata.

In some embodiments, as the processor component 550 of each Network module 500 that performs such tests, those processor components 550 may also operate their respective interfaces 590 to relay the results of those tests and/or updates thereto to the Managing module 400 that is in communication with the collection server 2400, either directly thereto, or through another intervening Managing module 400. The Managing module 400 in communication with the collection server 2400 may also transmit a copy of the portions of metadata as originally generated and as updated by the results of those tests. Differences in the portions of metadata preceding and following such updates may provide an indication to be stored by the collection server 2400 of an attempt to configure the storage system 1000 that is being defeated by a condition affecting a portion of an interconnect and/or another factor, and which may be deemed a topic of interest.

In further executing the control routine 540, the processor component 550 may operate the interface 590 to exchange storage service requests, responses thereto and/or client data 130 with one or more of the client devices 100 via the client interconnect 199. The client devices 100 and the Network module(s) 500 of one or more active ones of the nodes 300a-d and 300y-z may interact with each other via the client interconnect 199 in accordance with a client/server model for the handling of client data 130. Stated differently, each of the client devices 100 may issue requests for storage services related to the storage of client data 130 to one or more of the nodes 300a-d and 300y-z that are active to engage in communications with the client devices 100. In so doing, the client devices 100 and the Network module 500 may exchange packets over the client interconnect 199 in which storage service requests may be transmitted to the Network module 500, responses (e.g., indications of status of handling of the requests) may be transmitted to the client devices 100, and client data 130 may be exchanged therebetween. The exchanged packets may utilize any of a variety of file-based access protocols, including and not limited to, Common Internet File System (CIFS) protocol or Network File System (NFS) protocol, over TCP/IP. Alternatively or additionally, the exchanged packets may utilize any of a variety of block-based access protocols, including and not limited to, Small Computer Systems Interface (SCSI) protocol encapsulated over TCP (iSCSI) and/or SCSI encapsulated over Fibre Channel (FCP).

Also in executing the control routine 540, the processor component 550 may operate the interface 590 to exchange commands and/or data, including client data 130, with the Data module 600 via the intra-cluster interconnect 599a. Such exchanges of commands and/or data may or may not employ a protocol in which packets are used. In some embodiments, data access commands to effect exchanges of client data 130 may be exchanged through the intra-cluster interconnect 599a in a manner that may be agnostic of any particular file system that may be selected for use in storing the client data 130 within the set of storage devices 800ab. More specifically, the manner in which portions of client data 130 may be referred to in data access commands to store and/or retrieve client data 130 may entail identification of file names, identification of block identifiers, etc. in a manner meant to be independent of a selection of a file system.

Given the possible differences in protocols and/or other aspects of communications, the processor component 550 may be caused to translate between protocols employed in communications with one or more of the client devices 100 via the client interconnect 199 and protocols employed in communications with the Data module 600 via the intra-cluster interconnect 599a. Alternatively or additionally, one or more of the protocols employed in communications via the client interconnect 199 may employ file and/or block identification in a manner enabling a minimal degree of protocol translation between such communications and communications via the intra-cluster interconnect 599a.

In performing such protocol translations, the processor component 550 may be caused to relay a storage service request from one of the client devices 100 to the Data module 600 as one or more data access commands to store and/or retrieve client data 130. More specifically, a request received via the client interconnect 199 for storage services to retrieve client data 130 may be converted into one or more data access commands conveyed to the Data module 600 via the intra-cluster interconnect 599a to retrieve client data 130 from the set of storage devices 800ab and to provide the client data 130 to the Network module 500 to be relayed by the Network module 500 back to the requesting one of the client devices 100. Also, a request received via the client interconnect 199 for storage services to store client data 130 may be converted into one or more data access commands conveyed to the Data module 600 via the intra-cluster interconnect 599a to store the client data 130 within the set of storage devices 800ab.

In various embodiments, the Data module 600 of each of the nodes 300a-b incorporates one or more of a processor component 650, a memory 660, a storage controller 665 to couple the Data module 600 to the set of storage devices 800ab via the storage interconnect 899ab, and an interface 690 to couple the Data module 600 to one or more of the intra-cluster interconnect 599a, the inter-cluster interconnect 399 and the HA interconnect 699ab. The memory 660 stores one or more of a control routine 640 and metadata 630ab. Also, and as will be explained in greater detail, in the Data module 600 of the node 300a, a portion of the memory 660 may be allocated to serve as a synchronization cache (sync cache) 639a, while a portion of the memory 660 may be similarly allocated to serve as a sync cache 639b in the D-module of the node 300b. The control routine 640 incorporates a sequence of instructions operative on the processor component 650 in its role as a main processor component of the Data module 600 to implement logic to perform various functions. However, as a result of the node 300a being active to engage in communications with one or more of the client devices 100 and to perform data access commands, a different portion of the control routine 640 may be executed by the processor component 650 of the Data module 600 of the node 300a from a portion of the control routine 640 that may be executed by the processor component 650 of the D-module of the node 300b. As a result, different logic may be implemented by the executions of different portions of the control routine 640 within each of these Data modules 600.

In executing the control routine 640, the processor component 650 of the Data module 600 of the active node 300a may operate the interface 690 to receive portions of metadata and/or updates thereto from the Managing module 400 and/or the Network module 500 via the intra-cluster interconnect 599a. Regardless of whether aspects of the operation of at least the node 300a are remotely configured via the Managing module 400 and/or are configured based on the results of tests performed by the Network module 500, the processor component 650 may generate the metadata 630ab from those received metadata portions indicating the resulting configuration of those aspects, and may store the metadata 630ab within the memory 660 for subsequent use by the processor component 650. The processor component 650 may repeat the generation of the metadata 630ab in response to receiving updated portion(s) of metadata from the Managing module 400, the Network module 500 and/or other possible sources of updated metadata portions, thereby creating an updated version of the metadata 630ab which the processor component 650 may store within the memory 660 in place of earlier version(s). Following generation of the metadata 630ab and/or each updated version thereof, the processor component 650 may store the metadata 630ab within the set of storage devices 800ab for later retrieval during a subsequent rebooting of at least the Data module 600 of the node 300a.

Also following generation of the metadata 630ab and/or each updated version thereof, the processor component 650 of the Data module 600 of the node 300a may operate the interface 690 to transmit a duplicate of the metadata 630ab to the Data module 600 of the inactive node 300b via the HA interconnect 699ab to enable the node 300b to more speedily take over for the active node 300a in response to a failure within the node 300a. In this way, the node 300b is directly provided with the metadata 630ab and/or updated versions thereof to provide information needed by the node 300b to more readily take over communications with one or more client devices, take over communications with one or more others of the nodes 300c-d and/or 300y-z, and/or take over control of and/or access to the set of storage devices 800ab.

Still further following generation of the metadata 630ab and/or each updated version thereof, the processor component 650 of the Data module 600 of the node 300a may operate the interface 690 to transmit a portion of the metadata 630ab to the Data module 600 of an active one of the nodes 300y-z of the HA group 1600yz of the other cluster 1300z. Alternatively or additionally, the processor component 650 of the Data module 600 of the node 300a may operate the interface 690 to transmit metadata portion(s) received from the Managing module 400 and/or the Network module 500 of the node 300a to the active one of the nodes 300y-z. Such metadata portion(s) may include indications of aspects of operation of all of the nodes 300a-b and 300y-z together in storing and/or providing access to the client data 130, and may be provided to the active one of the nodes 300y-z as an input to other metadata that may be separately generated and/or maintained by the nodes 300y-z.

In some embodiments, as the processor component 650 of at least the Data module 600 receives metadata portions (or updates thereto) and generates each new version of the metadata 630ab, the processor component 650 may operate the interface 690 to relay each new version of the metadata 630ab to the Managing module 400 that is in communication with the collection server 2400 of the administration system 2000 through one or more Network modules 500. As previously discussed, the Managing module 400 in communication with the collection server 2400 may also transmit a copies of the portions of metadata from which the metadata 630ab is derived, and in so doing, may transmit a copy of the metadata 630ab with those metadata portions.

In further executing the control routine 640, the processor component 650 of the Data module 600 of the node 300a may operate the set of storage devices 800ab through the storage controller 665 to store and retrieve client data 130 in response to data access commands to do so received via the intra-cluster interconnect 599a, as has been described. The processor component 650 may operate the interface 690 to receive the data access commands from and/or exchange data (including client data 130) with the Network module 500 via the intra-cluster interconnect 599a. The processor component 650 may be caused to retry the performance of a data access command to store or retrieve client data 130 at least in response to the occurrence of a short term failure in performance (e.g., a failure that is likely to be resolved relatively quickly). However, if the failure in performance is a longer term failure (e.g., a failure that cannot be resolved quickly and/or requires intervention of personnel), then a takeover may occur in which, for example, the node 300b becomes the new active node of the HA group 1600ab.

In addition to operating the storage controller 665 to execute data access commands to store client data 130 within the set of storage devices 800ab and/or retrieve client data 130 therefrom, the processor component 650 of the Data module 600 of the node 300a may also replicate the data access commands and operate the interface 690 to transmit the resulting replica data access commands via the inter-cluster interconnect 399 to a Data module 600 of an active one of the nodes 300y-z of the HA group 1600yz of the other cluster 1300z. As has been discussed, the transmission of such replica data access commands to an active node of another HA group may provide an additional degree of fault tolerance in the storage and/or retrieval of client data 130 in which the replica data access commands may be performed by an active node of another cluster at least partly in parallel with the performance of the original data access command by the node 300a. The processor component 650 may be caused to retry the transmission of such replica data access commands to either the same active one of the nodes 300y-z within the HA group 1600yz and/or to a different inactive one of the nodes 300y-z within the HA group 1600yz in response to indications of errors in either the receipt or performance of the replica data access commands. Retrying transmission of replica data access commands to an inactive one of the nodes 300y-z may cause or arise from a takeover of the active one of the nodes 300y-z by the inactive one thereof.

In support of such exchanges of replica data access commands and responses thereto between the Data module 600 of the node 300a and a Data module 600 of an active one of the nodes 300y-z, the processor component 650 of the Data module 600 of the node 300a may employ information included within the metadata 630ab to form an active communications session with the Data module 600 of that other active node through the inter-cluster interconnect 399. The processor component 650 may additionally form an inactive communications session with a D-module of the inactive one of the nodes 300y-z through the inter-cluster interconnect 399 in preparation for retrying a transmission of a replica data access command to the Data module 600 of that inactive node. Further, if the processor component 650 retries the transmission of a replica data access command to the Data module 600 of that inactive one node, then the processor component 650 may act to change the state of the inactive communications session formed with the Data module 600 of that inactive node from inactive to active.

In executing the control routine 640, the processor component 650 of the Data module 600 of the inactive node 300b may operate the interface 690 to receive the metadata 630ab and/or updates thereto from the Data module 600 of the node 300a via the HA interconnect 699ab. The processor component 650 may then store the received metadata 630ab and/or the received updates thereto within the memory 660 for subsequent use. Again, provision of the metadata 630ab and updates thereto directly to the node 300b by the node 300a may be deemed desirable to enable the node 300b to more quickly take over for the node 300a (thereby transitioning from being an inactive node of the HA group 1600ab to becoming the active node of the HA group 1600ab) in response to a failure occurring within the node 300a. More specifically, with the metadata 630ab already provided to the Data module 600 of the node 300b, the need for the processor component 650 of the Data module 600 of the node 300b to take additional time to retrieve the metadata 630ab from other sources is alleviated. More precisely, the need for the processor component to retrieve the metadata 630ab from the set of storage devices 800ab, or to request portions of metadata from the Managing module 400 and/or the Network module 500 of either of the nodes 300a or 300b upon taking over for the node 300a is alleviated.

As depicted, the metadata 630ab may include immutable metadata 631ab and mutable metadata 632ab. What pieces of metadata are included in each of the immutable metadata 631ab and the mutable metadata 632ab may be based on the relative frequency with which each piece of metadata is expected to change. By way of example, aspects of the storage of client data 130 within the set of storage devices 800ab, such as a selection of file system, a “level” of redundancy of a Redundant Array of Independent Disks (RAID), etc. may be deemed immutable as a result of being deemed less likely to change or likely to change less frequently than other metadata. In contrast, a network address of a M-module, a N-module or a D-module of one of the other nodes 300a-d or 300y-z with which the node 300a may communicate via one of the interconnects 399, 599a or 699ab may be deemed mutable as a result of being deemed more likely to change or likely to change more frequently than other metadata.

As part of determining whether one of the nodes 300a or 300b needs to take over for the other, the processor components 650 of the D-modules of each of the nodes 300a and 300b may cooperate to recurringly exchange indications of the status of their nodes via the HA interconnect 699ab extending therebetween. As previously discussed such exchanges of status indications may take the form of recurring “heartbeat” signals and/or indications of the current state of performing an operation (e.g., a performing a data access command). Again, an indication that a component of one of the nodes 300a-b has suffered a malfunction may be the lack of receipt of an expected heartbeat signal or other status indication by the other of the nodes 300a-b within a specified period of time (e.g., within a recurring interval of time). Where the Data module 600 of the active node 300a receives an indication of a failure within the inactive node 300b, the processor component 650 of the Data module 600 of the node 300a (or another component of the node 300a) may refrain from taking action to take over the node 300b, since the node 300b is inactive such that the node 300b may not be performing a task that requires a takeover of the node 300b.

However, where the Data module 600 of the inactive node 300b receives an indication of a failure within the active node 300a, the processor component 650 of the Data module 600 of the inactive node 300b (or another component of the inactive node 300b) may take action to take over the node 300a, since the node 300a is active to engage in communications with the client devices 100, to perform data access commands, and to cooperate with another active node to cause at least partial parallel performance of data access commands therebetween. By way of example, the processor component 650 of the Data module 600 of the node 300b may signal the Network module 500 of the node 300b to take over communications with one or more of the client devices 100 and/or may begin performing the data access commands that were performed by the processor component 650 of the Data module 600 of the node 300a. In taking over the performance of those data access commands, the processor component 650 of the Data module 600 of the node 300b may take over access to and control of the set of storage devices 800ab via the coupling that the Data modules 600 of both of the nodes 300a and 300b share to the set of storage devices 800ab through the storage interconnect 899ab.

Where the inactive node 300b does take over for the active node 300a in response to a failure occurring within the node 300a, the active and inactive roles of the nodes 300a and 300b may fully reverse, at least after the failure within the node 300a has been corrected. More specifically, the Managing module 400 and the Network module 500 of the node 300b may become active to engage in communications with the client devices 100 and/or the administration device 200 via the client interconnect 199 to receive configuration information and storage service requests, and thereby take over for the Managing module 400 and the Network module 500 of the node 300a, while the Managing module 400 and the Network module 500 of the node 300a become inactive. Similarly, the Data module 600 of the node 300b may become active to perform and replicate data access commands, and to transmit replica data access commands to another active node via the inter-cluster interconnect 399 to cause at least partial parallel performance of the data access commands, and thereby take over for the Data module 600 of the node 300a, while the Data module 600 of the node 300a becomes inactive. However, in becoming active, the processor component 650 of the Data module 600 of the now inactive node 300a may cooperate with the processor component 650 of the Data module 600 of the node 300b to receive new versions of the metadata 630ab generated within the node 300b and to exchange indications of status with the Data module 600 of the node 300b via the HA interconnect 699ab to determine if the node 300a should subsequently take over for the now active node 300b.

The processor components 650 of the Data modules 600 of each of the nodes 300a and 300b may designate or otherwise use a portion of corresponding ones of the memories 660 as the sync caches 639a and 639b, respectively, in communications with Data module(s) 600 of others of the nodes 300a-d and/or 300y-z. More specifically, the processor components 650 of the Data modules 600 of the nodes 300a and 300b may employ the sync caches 639a and 639b, respectively, to buffer versions of the metadata 630ab and/or status indications exchanged therebetween. Alternatively or additionally, the processor component 650 of the Data module 600 of the node 300a may maintain and employ the sync cache 639a to buffer replica data access commands transmitted to another active node of another HA pair of another cluster and/or indications of status of performance of those replica data access commands received from that other active node.

As the processor components 550 of Network modules 500 and the processor components 650 of Data modules 600 within active ones of the nodes 300a-d and 300y-z execute relevant portions of the control routines 540 and 640, respectively, to handle requests for storages services received from one or more of the client devices 100, each of those processor components 550 and 650 may monitor various aspects of the performance and usage of the storage system 1000. By way of example, each of such processor components 550 may monitor the rates at which requests for storage services are received and relayed, the amount of time required to do so, the rate of throughput of client data 130 exchanged through active ones of the Network modules 500, and any instances in which a specified maximum or other high rate of throughput of client data 130 is reached or exceeded. Also by way of example, each of such processor components 650 may monitor the quantities of client data 130 stored within and/or amounts of storage capacity still available within associated ones of the sets of storage devices 800ab, 800cd and/or 800yz, data rates at which client data 130 is stored or retrieved, and any instances in which an access to one or more storage devices needed to be retried. Such processor components 550 and 650 may operate corresponding ones of the interfaces 590 and 690, respectively, to relay such information to the Managing module 400 that is in communication with the collection server 2400, either directly thereto or through another intervening Managing module 400. The one of the Managing modules 400 in communication with the collection server 2400 may, in turn, relay such information to the collection server 2400.

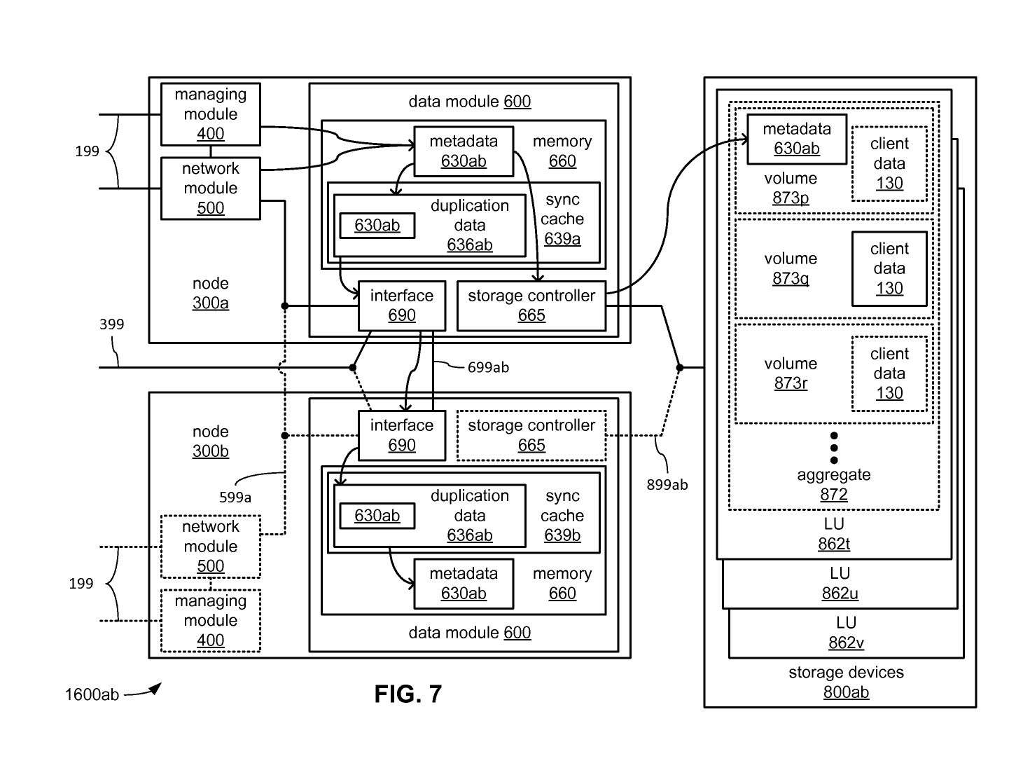

FIG. 7 illustrates a block diagram of another example embodiment of the HA group 1600ab of the cluster 1300a of the storage system 1000 in greater detail. As again depicted, of the nodes 300a and 300b of the HA group 1600ab, the node 300a may be active to engage in communications with a client device 100 and/or the administration device 200, and/or may be active to perform operations altering the client data 130 within the set of storage devices 800ab, while the node 300b may be inactive and awaiting a need to take over for the node 300a. FIG. 7 also depicts various aspects of the generation, duplication and storage of the metadata 630ab within the set of storage devices 800ab alongside the client data 130 in greater detail.

Each of the sets of storage devices 800ab, 800cd and 800yz may be made up of storage devices based on any of a variety of storage technologies, including and not limited to, ferromagnetic “hard” or “floppy” drives, magneto-optical media drives, optical media drives, non-volatile solid state drives, etc. As depicted, the set of storage devices 800ab may include LUs 862t-v that may be operated together to form an array of storage devices. In some embodiments, the processor component 650 of the Data module 600 of the node 300a may operate the storage controller 665 to treat each of the storage devices of the set of storage devices 800ab as a separate LU and/or may be caused to treat a group of those storage devices as a single LU. Multiple LUs may be operated together via the storage controller 665 to implement a level of RAID or other form of array that imparts fault tolerance in the storage of data therein. The manner in which LUs are defined among one or more storage devices of the set of storage devices 800ab, and/or the manner in which multiple LUs may be operated together may be specified within the metadata 630ab.

The processor component 650 may be caused to allocate storage space in any of a variety of ways within a single LU and/or within multiple LUs operated together to form an array. In so doing, the processor component 650 may be caused to subdivide storage space in any of a variety of ways within a single LU and/or within multiple LUs that are operated together. By way of example, such subdivisions may be effected as part of organizing client data 130 into separate categories based on subject, as part of separating client data 130 into different versions generated over time, as part of implementing differing access policies to different pieces of client data 130, etc. In some embodiments, and as depicted, the storage space provided by within the LU 862t or within a combination of the LUs 862t-v may be designated as an aggregate 872. Further, the aggregate 872 may be subdivided into volumes 873p-r. The manner in which aggregates and/or volumes are defined may be selected to conform to the specification(s) of one or more widely known and used file systems, including and not limited to, Write Anywhere File Layout (WAFL). The manner in which aggregates and/or volumes within aggregates are allocated among a single LU or multiple LUs that are operated together may be specified within the metadata 630ab.

The client data 130 may be stored entirely within one of the volumes 873p-r, or may be distributed among multiple ones of the volumes 873p-r (as depicted). As also depicted, the metadata 630ab may also be stored within the set of storage devices 800ab along with client data 130, at least within the same aggregate 872. In some embodiments, the metadata 630ab may be stored within one or more of the same volumes 873p-r as client data 130 (as depicted). In other embodiments, the metadata 630ab may be stored within one of the volumes 873p-r that is separate from one or more others of the volumes 873p-r within which client data 130 may be stored. The manner in which the metadata 630ab and/or the client data 130 are to be organized within aggregates and/or values may be specified within the metadata 630ab itself.

As previously discussed, the Managing module 400 of the active node 300a may provide portions of metadata, including updates thereof, to the Network module 500 and/or the Data module 600 in response to receiving configuration information from one of the client devices 100. Again, such portions of metadata so provided by the Managing module 400 (and/or updates thereto) may include configuration information received in configuration data from the administration device 200 and/or one or more of the client devices 100. Also, the Network module 500 of the active node 300a may provide portions of metadata, including updates thereof, to the Data module 600 that indicate results of various tests performed by the Network module 500. Again, the portions of metadata so provided by the Network module 500 (and/or updates thereto) may include configuration information derived by the Network module 500 through the performance of various tests. And again, a duplicate of the metadata 630ab may be generated and stored within the sync cache 639a as a portion of duplication data 636ab, by which the duplicate of the metadata 630ab may be transmitted via the interface 690 and the HA interconnect 699ab to the Data module 600 of the inactive node 300b.

As the processor component 650 of the Data module 600 of one or more of the active nodes 300a-d and 300y-z are caused to create aggregates and/or volumes in corresponding ones of the sets of storage devices 800ab, 800cd and 800yz, those processor components 650 may monitor the process of doing so and record various results of those processes, such as failures in particular storage devices, instances of needing to resize one aggregate or volume to accommodate an expansion of another, and instances of automatically increasing the size of a volume or aggregate as a result of the storage of a larger quantity of client data 130 than could be accommodated by the original defined capacity of that volume or aggregate. Again, those ones of the processor component 650 may operate corresponding ones of the interfaces 690 to relay such information to the one of the Managing modules 400 that is in communication with the collection server 2400 to be relayed thereto.

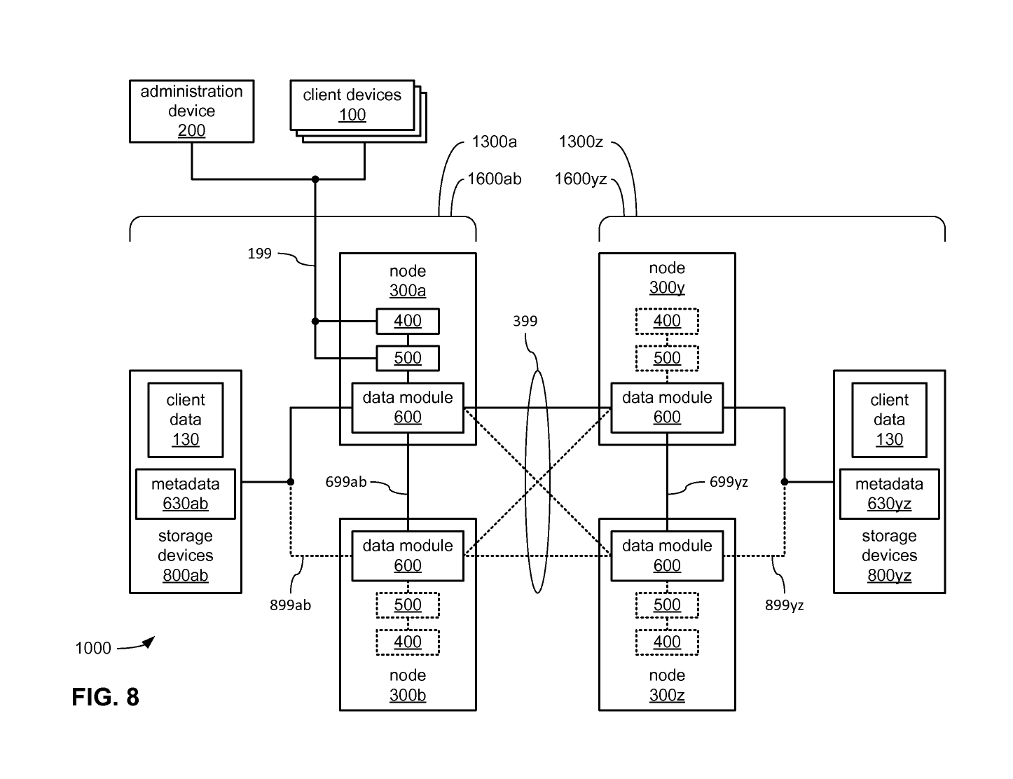

FIG. 8 depicts an example embodiment of a mesh of communications sessions formed among the nodes 300a-b and 300y-z through the inter-cluster interconnect 399 in greater detail. More specifically, through the inter-cluster interconnect 399, each of the nodes 300a and 300b of the HA group 1600ab forms a communications session with each of the nodes 300y and 300z of the HA group 1600yz, thereby forming the depicted mesh of communications sessions among the nodes 300a-b and 300y-z. As depicted, of these communications sessions, the communications session extending between the nodes 300a and 300y may be an active communications session (as indicated with a solid line), while the others of these communications sessions may be inactive communications sessions (as indicated with dotted lines). This reflects the fact that the nodes 300a and 300y, at least initially, are each the active nodes of the HA groups 1600ab and 1600yz, respectively, that engage in communications to exchange replica data access commands and associated data to enable at least partly parallel performance of data access commands between the HA groups 1600ab and 1600yz.

Thus, during normal operation of the storage system 1000 in which the nodes 300a and 300y are active nodes and no errors occur within either of the nodes 300a or 300y, a request for storage services is received by the node 300a via the client interconnect 199 from one of the client devices 100. Following conversion of the storage services request into a data access command by the Network module 500 of the node 300a, the Data module 600 of the node 300a may both begin performance of the data access command and transmit a replica of that data access command to the node 300y via the active communications session formed through inter-cluster interconnect 399 between the nodes 300a and 300y. The Data module 600 of the node 300y may then perform the replica data access command at least partly in parallel with the performance of the data access command by the Data module 600 of the node 300a.

In preparation for such a transmission, the Data module 600 of the node 300a may cooperate with the Data module 600 of the node 300y to form the depicted active communications session between the nodes 300a to 300y through an exchange of messages requesting and accepting formation of the active communications session. Following its formation, the Data modules 600 of the nodes 300a and 300y may cooperate to maintain the active communications session by recurring exchanges of test signals (e.g., test messages) therethrough to monitor the state of the active communications session.

In addition to the Data modules 600 of the nodes 300a and 300y cooperating to form and maintain the depicted active communications session through the inter-cluster interconnect 399 to support such exchanges of replica data access commands, the Data modules 600 of all of the nodes 300a-b and 300y-z may cooperate to form and maintain the depicted inactive communications sessions through the inter-cluster interconnect 399 in preparation for handling an error condition affecting one of the nodes 300a or 300y. More specifically, test signals (e.g., test messages) may be exchanged through one or more of the inactive communications sessions to monitor their state.

In the event of a failure of at least a portion of the node 300a, the node 300b may take over for the node 300a, and in so doing, may change the state of the inactive communications session extending between the Data modules 600 of the nodes 300b and 300y into an active communications session. By doing so, the node 300b becomes able to transmit replica data access commands to the node 300y in place of the node 300a. Correspondingly, in the event of a failure of at least a portion of the node 300y, the node 300z may take over for the node 300y, and in so doing, may change the state of the inactive communications session extending between the Data modules 600 of the nodes 300a and 300z into an active communications session. By doing so, the node 300z becomes able to receive and perform replica data access commands from the node 300a in place of the node 300y. In either of these events, the active communications session extending between the D-modules of the nodes 300a and 300y may become inactive. In some embodiments, indications of such changes in which communication sessions are active and/or inactive may be relayed to the one of the Managing modules 400 that is in communication with the collection server 2400 to enable those indications to be relayed onward to the collection server 2400 alongside indications of which communication sessions were originally configured to be active, at least by default.

In various embodiments, each of the processor components 450, 550, 650, 2450, 2550, 2650 and 2850 may include any of a wide variety of commercially available processors. Also, one or more of these processor components may include multiple processors, a multi-threaded processor, a multi-core processor (whether the multiple cores coexist on the same or separate dies), and/or a multi processor architecture of some other variety by which multiple physically separate processors are in some way linked.

In various embodiments, each of the control routines 440, 540, 640, 2440, 2540, 2640 and 2840 may include one or more of an operating system, device drivers and/or application-level routines (e.g., so-called “software suites” provided on disc media, “applets” obtained from a remote server, etc.). As recognizable to those skilled in the art, each of the control routines 440, 540 and 640, including the components of which each may be composed, are selected to be operative on whatever type of processor or processors may be selected to implement applicable ones of the processor components 450, 550 or 650, or to be operative on whatever type of processor or processors may be selected to implement a shared processor component. In particular, where an operating system is included, the operating system may be any of a variety of available operating systems appropriate for corresponding ones of the processor components 450, 550 or 650, or appropriate for a shared processor component. Also, where one or more device drivers are included, those device drivers may provide support for any of a variety of other components, whether hardware or software components, of corresponding ones of the modules 400, 500 or 600.

In various embodiments, each of the memories 460, 560 and 660 and/or each of the storages 2460, 2560, 2660 and 2860 may be based on any of a wide variety of information storage technologies, possibly including volatile technologies requiring the uninterrupted provision of electric power, and possibly including technologies entailing the use of machine-readable storage media that may or may not be removable. Thus, each of these memories may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a RAID array). It should be noted that although each of these memories is depicted as a single block, one or more of these may include multiple storage devices that may be based on differing storage technologies. Thus, for example, one or more of each of these depicted memories may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these memories may be made up of multiple storage components based on identical storage technology, but which may be maintained separately as a result of specialization in use (e.g., some DRAM devices employed as a main memory while other DRAM devices employed as a distinct frame buffer of a graphics controller).

In various embodiments, the interfaces 490, 590 and 690 may employ any of a wide variety of signaling technologies enabling these computing devices to be coupled to other devices as has been described. Each of these interfaces includes circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1×RTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

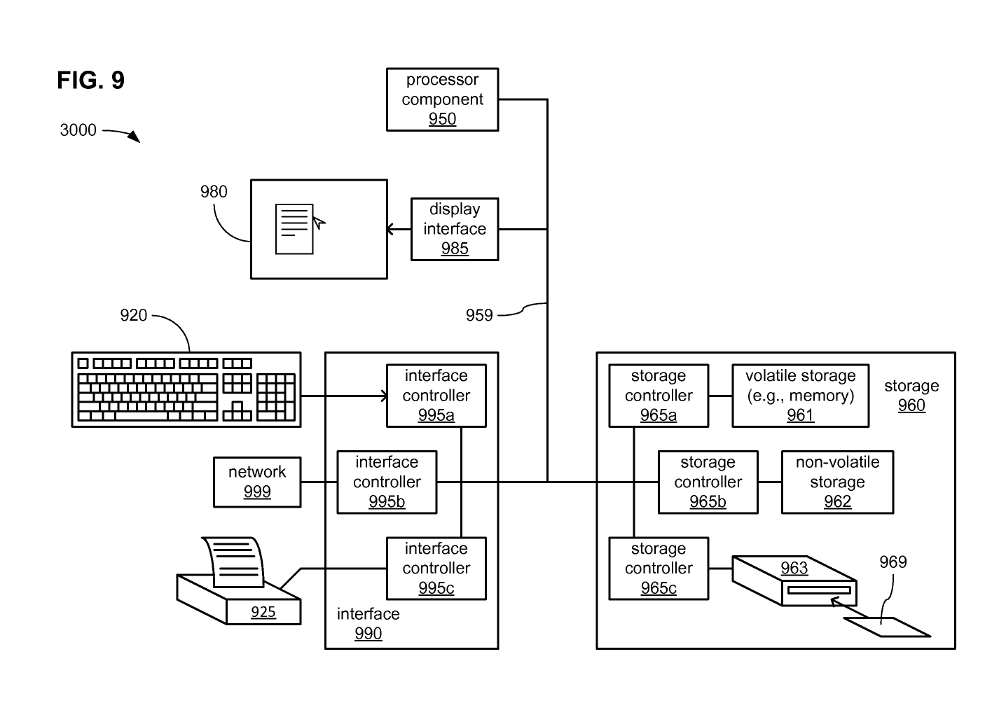

FIG. 9 illustrates an embodiment of an exemplary processing architecture 3000 suitable for implementing various embodiments as previously described. More specifically, the processing architecture 3000 (or variants thereof) may be implemented as part of one or more of the client devices 100, the administration devices 200, the nodes 300, the management modules 400, the network modules 500, the data modules 600, the authoring devices 2100, the administration devices 2200, the collection server 2400, the enrollment server 2500, the distribution server 2600, the documentation server 2800, and the sets of storage devices 800ab, 800cd or 800yz. It should be noted that components of the processing architecture 3000 are given reference numbers in which the last two digits correspond to the last two digits of reference numbers of at least some of the components earlier depicted and described as part of the devices 100, 200, 800, 2100 and/or 2200; the servers 2400, 2500, 2600 and/or 2800; and/or the modules 400, 500 and 600. This is done as an aid to correlating components of each.

The processing architecture 3000 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor component, the processor component itself, a storage device (e.g., a hard disk drive, multiple storage drives in an array, etc.) that may employ an optical and/or magnetic storage medium, a software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. A message (including a command, status, address or data message) may be one of such signals or may be a plurality of such signals, and may be transmitted either serially or substantially in parallel through any of a variety of connections and/or interfaces.

As depicted, in implementing the processing architecture 3000, a computing device includes at least a processor component 950, an internal storage 960, an interface 990 to other devices, and a coupling 959. As will be explained, depending on various aspects of a computing device implementing the processing architecture 3000, including its intended use and/or conditions of use, such a computing device may further include additional components, such as without limitation, a display interface 985.

The coupling 959 includes one or more buses, point-to-point interconnects, transceivers, buffers, crosspoint switches, and/or other conductors and/or logic that communicatively couples at least the processor component 950 to the internal storage 960. Coupling 959 may further couple the processor component 950 to one or more of the interface 990 and the display interface 985 (depending on which of these and/or other components are also present). With the processor component 950 being so coupled by couplings 959, the processor component 950 is able to perform the various ones of the tasks described at length, above, for whichever one(s) of the aforedescribed computing devices implement the processing architecture 3000. Coupling 959 may be implemented with any of a variety of technologies or combinations of technologies by which signals are optically and/or electrically conveyed. Further, at least portions of couplings 959 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor component 950 may include any of a wide variety of commercially available processors, employing any of a wide variety of technologies and implemented with one or more cores physically combined in any of a number of ways.

As previously discussed, the internal storage 960 may be made up of one or more distinct storage devices based on any of a wide variety of technologies or combinations of technologies. More specifically, as depicted, the internal storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the internal storage 960 as possibly including multiple distinct types of storage is in recognition of the commonplace use of more than one type of storage device in computing devices in which one type provides relatively rapid reading and writing capabilities enabling more rapid manipulation of data by the processor component 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 959 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 959 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 959 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may include an article of manufacture in the form of a machine-readable storage media on which a routine including a sequence of instructions executable by the processor component 950 may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data.

Thus, a routine including a sequence of instructions to be executed by the processor component 950 may initially be stored on the machine-readable storage medium 969, and the removable media storage 963 may be subsequently employed in copying that routine to the non-volatile storage 962 for long-term storage not requiring the continuing presence of the machine-readable storage medium 969 and/or the volatile storage 961 to enable more rapid access by the processor component 950 as that routine is executed.

As previously discussed, the interface 990 may employ any of a variety of signaling technologies corresponding to any of a variety of communications technologies that may be employed to communicatively couple a computing device to one or more other devices. Again, one or both of various forms of wired or wireless signaling may be employed to enable the processor component 950 to interact with input/output devices (e.g., the depicted example keyboard 920 or printer 925) and/or other computing devices, possibly through a network (e.g., the network 999) or an interconnected set of networks. In recognition of the often greatly different character of multiple types of signaling and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network made up of one or more links, smaller networks, or perhaps the Internet). The interface controller 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, a microphone to monitor sounds of persons to accept commands and/or data signaled by those persons via voice or other sounds they may make, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data signaled by those persons via gestures and/or facial expressions, laser printers, inkjet printers, mechanical robots, milling machines, etc.

Where a computing device is communicatively coupled to (or perhaps, actually incorporates) a display (e.g., the depicted example display 980), such a computing device implementing the processing architecture 3000 may also include the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

More generally, the various elements of the computing devices described and depicted herein may include various hardware elements, software elements, or a combination of both. Examples of hardware elements may include devices, logic devices, components, processors, microprocessors, circuits, processor components, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

1. An apparatus comprising:
a processor component of an enrollment server;
a selection component of the enrollment server to analyze an aspect of storage of client data by at least one storage device of a storage system to determine a topic of interest to operation of the storage system, and to enroll an administration device of the storage system as a recipient of a news feed based on the topic of interest; and
a triggering component of the enrollment server to trigger a distribution server to transmit a document associated with the news feed to the administration device in response to the enrollment of the administration device.

2. The apparatus of claim 1, comprising a retrieval component to retrieve an indication of the aspect of the storage of the client data from a collection server, the collection server to receive recurring indications of multiple aspects of the storage of the client data from the storage system via a network.

3. The apparatus of claim 2, comprising a server, the server comprising the processor component, the enrollment server comprising a first virtual machine generated by the processor component within the server, and the collection server comprising a second virtual machine generated by the processor component within the server.

4. The apparatus of claim 1, the selection component to analyze another aspect of the storage of the client data to determine whether the topic of interest is still a topic of interest, and to remove the administration device from the enrollment in response to a determination that the topic of interest is no longer a topic of interest.

5. The apparatus of claim 4, the triggering component to trigger the distribution server to transmit another document associated with the news feed to the administration device in response to the removal of the administration device from the enrollment.

6. The apparatus of claim 5, comprising a server, the server comprising the processor component, the enrollment server comprising a first virtual machine generated by the processor component within the server, and the distribution server comprising a second virtual machine generated by the processor component within the server.

7. The apparatus of claim 1, comprising a tagging component to analyze content of the document to determine whether the document meets specified criterion to be associated with the topic of interest and to tag the document as associated with the topic of interest based on the determination, the specified criterion to be specified in tag data that is to correlate each topic of multiple topics to a criterion of multiple criterion, the multiple topics to comprise the topic of interest and the multiple criterion to comprise the specified criterion.

8. The apparatus of claim 1, comprising a retrieval component to retrieve recurring indications of multiple aspects of the storage of the client data from the storage system via a network, the indications to comprise metadata that indicates aspects of a configuration of the storage system.

9. A computer-implemented method comprising:
analyzing an aspect of storage of client data by at least one storage device of a storage system to determine a topic of interest to operating the storage system;
enrolling an administration device of the storage system as a recipient of a news feed based on the topic of interest; and
transmitting an indication of the enrollment of the administration device to a distribution server to trigger the distribution server to transmit a document associated with the news feed to the administration device in response to the enrollment of the administration device.

10. The computer-implemented method of claim 9, comprising:
receiving from the storage system, via a network, recurringly transmitted indications of multiple aspects of the storage of the client data;
storing the multiple indications in an account entry of multiple account entries of an account database, each account entry corresponding to at least one of multiple storage systems, the multiple storage systems comprising the storage system; and
retrieving the indication of the aspect of the storage of the client data from the account entry.

11. The computer-implemented method of claim 9, comprising:
analyzing another aspect of the storage of the client data to determine whether the topic of interest is still a topic of interest; and
removing the administration device from the enrollment in response to a determination that the topic of interest is no longer a topic of interest.

12. The computer-implemented method of claim 11, comprising transmitting an indication of the removal of the administration device from the enrollment to the distribution server to trigger the distribution server to transmit another document associated with the news feed to the administration device in response to the removal of the administration device from the enrollment.

13. The computer-implemented method of claim 9, comprising analyzing content of the document to determine whether the document meets criterion of multiple criterion correlated to multiple topics to determine whether the document is associated with the topic of interest, the multiple topics comprising the topic of interest.

14. The computer-implemented method of claim 9, the aspect of storage comprising at least one of a manner in which components of the storage system are coupled, a feature of a component of the storage system that is used, a feature of a component of the storage system that is not used, a client application for which client data is stored, a type of data stored as the client data, a quantity of the client data that is stored, an occurrence of a failure of a component of the storage system, an instance of reaching a storage capacity limit, an instance of reaching a bandwidth limit, a change to a configuration of a volume, or a change to a coupling among components of the storage system.

15. At least one machine-readable storage medium comprising instructions that when executed by a processor component of an administration system, cause the processor component to:
analyze an aspect of storage of client data by at least one storage device of a storage system to determine a topic of interest to operation of the storage system;
enroll an administration device of the storage system as a recipient of a news feed based on the topic of interest; and
transmit a document associated with the news feed to the administration device in response to the enrollment of the administration device.

16. The at least one machine-readable storage medium of claim 15, the processor component caused to:
store indications of multiple aspects of the storage of the client data recurringly received from the storage system via a network in an account entry of multiple account entries of an account database, each account entry corresponding to at least one of multiple storage systems, the multiple storage systems comprising the storage system; and
retrieve the indication of the aspect of the storage of the client data from the account entry.

17. The at least one machine-readable storage medium of claim 15, the processor component caused to:
analyze another aspect of the storage of the client data to determine whether the topic of interest is still a topic of interest; and
remove the administration device from the enrollment in response to a determination that the topic of interest is no longer a topic of interest.

18. The at least one machine-readable storage medium of claim 17, the processor component caused to transmit another document associated with the news feed to the administration device in response to the removal of the administration device from the enrollment.

19. The at least one machine-readable storage medium of claim 15, the processor component caused to:
analyze content of the document to determine whether the document meets specified criterion to be associated with the topic of interest, the specified criterion to be specified in tag data that is to correlate each topic of multiple topics to a criterion of multiple criterion, the multiple topics to comprise the topic of interest and the multiple criterion to comprise the specified criterion; and
tag the document as associated with the topic of interest based on the determination.

20. The at least one machine-readable storage medium of claim 15, the processor component caused to retrieve recurring indications of multiple aspects of the storage of the client data from the storage system via a network, the indications to comprise metadata that indicates aspects of a configuration of the storage system.
